(19) United States
(12) Patent Application Publication
(10) Pub. No.: US 2026/0030279 A1
(43) Pub. Date: Jan. 29, 2026

(54) MASSIVE SCALE HETEROGENEOUS DATA INGESTION AND USER RESOLUTION

(71) Applicant: Experian Information Solutions, Inc., Costa Mesa, CA (US)

(72) Inventors: Anukool Rege, Basking Ridge, NJ (US); Prashant Kumar Sahay, West Windsor, NJ (US); Mervyn Lally, Laguna Niguel, CA (US); Shirish Kumar, Saratoga, CA (US); Sanskar Sahay, Princeton, NJ (US)

(21) Appl. No.: 19/261,842

(22) Filed: Jul. 7, 2025

Related U.S. Application Data
(63) Continuation of application No. 18/310,989, filed on May 2, 2023, now Pat. No. 12,386,875.
Application No. 18/310,989 is a continuation of application No. 17/457,757, filed on Dec. 6, 2021, now Pat. No. 11,681,733.
Application No. 17/457,757 is a continuation of application No. 15/885,239, filed on Jan. 31, 2018, now Pat. No. 11,227,001.
(60) Provisional application No. 62/452,701, filed on Jan. 31, 2017.

(51) Int. Cl. G06F 16/335; G06F 16/2457; G06F 16/901; G06F 16/9535; G06Q 40/03

(52) U.S. Cl. CPC G06F 16/337; G06F 16/24573; G06F 16/9014; G06Q 40/03; G06F 16/9535

(57) ABSTRACT

This disclosure relates to data association, attribution, annotation, and interpretation systems and related methods of efficiently organizing heterogeneous data at a massive scale. Incoming data is received and extracted for identifying information (“information”). Multiple dimensionality reducing functions are applied to the information, and based on the function results, the information are grouped into sets of similar information. Filtering rules are applied to the sets to exclude non-matching information in the sets. The sets are then merged into groups of information based on whether the sets contain at least one common information. A common link may be associated with information in a group. If the incoming data includes the identifying information associated with to the common link, the incoming data is assigned the common link. In some embodiments, incoming data are not altered but assigned into domains.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

This disclosure relates to data association, attribution, annotation, and interpretation systems and related methods of efficiently organizing heterogeneous data elements associated with users at a massive scale. The systems and methods can be implemented to provide real-time access to historical data elements of users that has not previously been available.

### BACKGROUND

Credit events can be collected, compiled, and analyzed to provide an individual's creditworthiness in the form of a credit report, which typically includes multiple credit attributes, such as a credit score, credit account information, and other information related to financial worthiness of users. For example, a credit score is important as it can establish necessary level of trust between transacting entities. For example, financial institutions such as lenders, credit card providers, banks, car dealers, brokers, or the like can more safely enter into a business transaction based on credit scores.

### SUMMARY

Systems and methods are disclosed related to data association, attribution, annotation, and interpretation system and related methods of efficiently organizing heterogeneous data at a massive scale.

One general aspect includes a computer system for determining account holder identities for collected event information, the computer system including: one or more hardware computer processors; and one or more storage devices configured to store software instructions configured for execution by the one or more hardware computer processors to cause the computer system to: receive, from a plurality of data sources, a plurality of event information associated with a corresponding plurality of events; for each event information: access a data store including associations between data sources and identifier parameters, the identifier parameters including at least an indication of one or more identifiers included in event information from the corresponding data source; determine, based at least on the identifier parameters of the data source of the event information, identifiers included in the event information as indicated in the accessed data store; extract identifiers from the event information based at least on the corresponding identifier parameters, where a combination of the identifiers include a unique identity associated with a unique user; access a plurality of hash function, each associated with a combination of identifiers; for each unique identity, calculate a plurality of hashes by evaluating the plurality of hash functions; based on whether unique identities share a common hash calculated with a common hash function, selectively group unique identities into sets of unique identities associated with common hashes; for each set of unique identities: apply one or more match rules including criteria for comparing unique identities within the set; determine a matching set of unique identities as those meeting one or more of the match rules; merge matching sets of unique identities each including at least one common unique identity to provide one or more merged sets having no unique identity in common with other merged sets; for each merged set: determine an inverted personal identifier; associate the inverted personal identifier to each of the unique identities in the merged set; for each unique identity: identify event information associated with at least one of the combinations of identifiers associated with the unique identity, and associate the inverted personal identifier with the identified event information. Other embodiments of this aspect include corresponding computer systems, apparatus, and computer programs recorded on one or more computer storage devices, each configured to perform the actions of the methods.

Implementations may include one or more of the following features. The computer system where the hash functions include at least: a first hash function that evaluates a first combination of at least portions of a first identifier and at least portions of a second identifier extracted from event information; and a second hash functions that evaluates a second combination of at least portions of the first identifier and at least portions of a third identifier extracted from event information; The computer system where the first hash function is selected based on identifier types of one or more of the first identifier or the second identifier. The computer system where the first identifier is a social security number of the user and the second identifier is a last name of the user, and the first combination is a concatenation less than all of the digits of the social security number and less than all characters of the last name of the user. The computer system where a first set of events includes a plurality of events associated with the first hash and a second set of events includes plurality of events each associated with the second hash. The computer system where the identifiers are selected from: first name, last name, middle initial, middle name, date of birth, social security number, taxpayer id, or national id. The computer system where the computer system generates an inverted map associating an inverted personal identifier to each of the remaining unique identities in the merged sets and stores the map in a data store. The computer system further including, based on the inverted personal identifier assigned to the remaining unique identities, assign the inverted personal identifier to each of the plurality of event information including the remaining unique identities. The computer system where the hash functions include locality sensitive hashing. The computer system where the one or more match rules include one or more identity resolution rules that compare u in the one or more sets with account holder information in an external database or CRM system to identify matches to the one or more match rules. The computer system where the identity resolution rules include criteria indicating match criteria between the account holder information and the identifiers. The computer system where the merging sets includes, for each of one or more sets, repeating the process of: pairing each unique identity in a set with another unique identity in the set to create pairs of unique identity; determining a common unique identity in pairs; and in response to determining the common unique identity, grouping noncommon unique identities from the pairs with the common unique identity until lists of unique identities contained within resulting groups are mutually exclusive between resulting groups. The computer system where the determining a common unique identity in pairs further includes sorting the unique identities in pairs. Implementations of the described techniques may include hardware, a method or process, or computer software on a computer-accessible medium.

Another general aspect includes a computer system including: one or more hardware computer processors, and one or more storage devices configured to store software instructions configured for execution by the one or more hardware computer processors to cause the computer system to: receive a plurality of events from one or more data sources, where at least some of the events have heterogeneous structures; store the events in the heterogeneous structures for access by external processes; for each of the data sources; identify a domain based at least in part on data structure or data from the data source; access a vocabulary associated with the identified domain; and for each event; determine whether the event matches some or all a vocabulary; associate the event with the corresponding domain or vocabulary; associate one or more tags with portions of the event based on the determined domain. Other embodiments of this aspect include corresponding computer systems, apparatus, and computer programs recorded on one or more computer storage devices, each configured to perform the actions of the methods.

Implementations may include one or more of the following features. The computer system further including the software instructions, when executed by the one or more hardware processors, are configured to cause the computer system to: receive a request for information associated with a user in a first domain; execute one or more domain parsers configured to identify events associated with the user having one or more tags associated with the first domain; and provide at least some of the identified events to a requesting entity. The computer system where the at least some of the identified events includes only those portions of the identified events associated with the one or more tags associated with the first domain. Implementations of the described techniques may include hardware, a method or process, or computer software on a computer-accessible medium.

Another general aspect includes a computerized method including, by a computing system having one or more computer processors: receiving a plurality of event information from one or more data sources, where the plurality of event information have heterogeneous data structures; determining a domain for each of the one or more data sources based at least in part on one or more of the data source, a data structure associated with the data source, or event information from the data source; accessing a domain dictionary associated with the determined domain including domain vocabulary, domain grammar, and/or annotation criteria; annotating one or more portions of event information from the determined domain with domain vocabulary where based on annotation criteria; receiving a request for event information or data included in event information; interpreting the event information based on the one or more annotated portions of the event information; and providing the requested data based on the interpretation. Other embodiments of this aspect include corresponding computer systems, apparatus, and computer programs recorded on one or more computer storage devices, each configured to perform the actions of the methods.

### BRIEF DESCRIPTION OF THE DRAWINGS

Certain embodiments will now be described with reference to the following drawings. Throughout the drawings, reference numbers may be re-used to indicate correspondence between referenced elements. The drawings are provided to illustrate example embodiments described herein and are not intended to limit the scope of the disclosure or the claims.

FIG. 1A illustrates an example credit data system of the present disclosure, according to some embodiments.

FIG. 1B illustrates an example generation, flow, and storage of credit data, according to some embodiments.

FIG. 2A illustrates an example sequential processing of a collection of heterogeneous events, according to some embodiments, according to some embodiments.

FIG. 2B illustrates an example credit data system interfacing with various applications or services, according to some embodiments.

FIG. 3 illustrates an example credit data system structure for simultaneous creation of the credit state and the credit associates for analytics, according to some embodiments.

FIG. 4 illustrates an example batch indexing process, including identity stripping, identity matching, and identity stamping in this embodiment.

FIG. 5 illustrates an example of identity stripping, according to some embodiments.

FIG. 6 illustrates an example process of reducing dimensionality of data using hash algorithms, according to some embodiments.

FIG. 7 illustrates an example identity resolution process, according to some embodiments.

FIG. 8 illustrates an example set merging process, according to some embodiments.

FIG. 9 illustrates an example of associating inverted personal identifiers (“inverted PIDs”) with unique identities, according to some embodiments.

FIG. 10 illustrates an example of stamping inverted PIDs to credit events, according to some embodiments.

FIGS. 11A-11D illustrate an example implementation of a sample identity matching process.

FIG. 12 is a flowchart of an example method for efficiently organizing heterogeneous data at a massive scale, according to some embodiments.

FIGS. 13A-13C illustrates example data models showing defect probability associated with data as the data flows from data ingestion to data consumption.

FIG. 14 illustrates various types of data sources that may provide heterogeneous event information regarding an individual, which may be accessed and analyzed in various embodiments.

FIG. 15 illustrates example domains and their associated vocabularies, according to some embodiments.

FIG. 16 illustrates an example system for and process of tagging event information and then used the tagged event information in providing data insights, according to some embodiments.

FIG. 17 is a flowchart of an example method for interpreting incoming data so as to minimize defect impact in the system, according to some embodiments.

### DETAILED DESCRIPTION OF EMBODIMENTS

This disclosure presents various architectures and embodiments of systems and methods related to data association, attribution, annotation, and interpretation systems and related methods of efficiently organizing heterogeneous data at a massive scale. The disclosed systems and methods can be implemented to provide credit data based on smart and efficient credit data architecture.

More accurate and reliable credit-related information can further boost the confidence levels of entities reviewing the credit-related information. For example, accurate and reliable provision of credit statement, cash flow, balance statement, credit score, or other credit attributes can more accurately paint the creditworthiness of an individual. Ideally, collecting all credit-related information related to an individual and updating the individual's credit attributes every time credit-related information is collected would provide such more accurate and reliable credit attributes. However, there are very real technical challenges that make it difficult to have more timely, accurate, and reliable credit attributes. The same or similar challenges may apply to other types of data collection, storage, analysis etc. For example, systems may also struggle with timely resolution of large masses of event data associated with travel-related events, crime-related events, educational-related events, etc. to particular individuals. Thus, any discussion herein of technical problems and solutions in the context of credit-related information are equally applicable to other types of information.

One technical challenge relates to dealing with sheer volume of credit events that need to be collected, analyzed, stored, and made accessible to requesting entities. For example, if there are 40 million people and each person has 20 accounts (e.g., bank accounts, mortgages, car leases, credit cards), there are 800 million accounts that are constantly generating credit events. By a modest assumption, if each credit event contains 1000 bytes of data, sheer volume of raw credit events for 12 months may be approximately 10 terabytes or more of data. If some internal guidelines or external regulations require 5 years of credit events to be archived, the volume may approach 50 terabytes. The challenge is further complicated by the trend of increasing digital transactions both from increasing population and increased digital transaction adoption. Traditional data collection models where collection and analysis of data are treated as distinct steps in a lateral process may fail to meet the demand for quick analytics, statements, and reports.

Another technical challenge relates to dealing with various formats of the event data. The events may be received from various entities, such as lenders, credit card providers, banks, car dealers, brokers, or the like. Often the entities provide credit events in their proprietary data structure or schema. The collected data are often stored in a database, such as a relational database, which, while providing benefits of structured organization with standard data structures, can be ill-equipped in collecting data having heterogeneous structures. Additionally, such databases may require resource-heavy processes of extract, transform, and load (ETL) operations. The ETL operations often also require extensive programming efforts in incorporating data structures from new data sources.

Even when collected data is successfully transformed to conform to database schemas provided by the databases, often the database schemas are too rigid to accommodate information. Expanding the database schemas can quickly become a gargantuan task as new data sources with disparate data structures continue to become available. Accordingly, database managers are put up against decisions to (1) trim extra information that may become important at some point (essentially trimming to fit square data into a round schema), or (2) disregard available nonconforming information altogether knowing that future analysis will be inaccurate. Both approaches are less than ideal as both approaches introduce incompleteness or inaccuracy.

In addition to challenges in collecting data, there also are technical challenges related to analysis. For example, such systems can be painfully slow to generate a credit report for an individual. From multiple terabytes of data (per year), the systems search for records matching a requesting individual in order to generate a credit statement. Such systems may take days or weeks to calculate credit statements for 40 million people. Not only does the delayed generation of the statements not reflect the current state of the individual, but also indicates that a significant amount of computing resources are tied to the task of generating the statements. This provides a non-optimal mechanism for detecting fraud through the credit data, since data on the credit reports may be several days stale by the time it is provided to the user. Further, even when the fraudulent transaction has been removed, it may take multiple days, weeks, or more for the change to be indicated on an updated credit report. Accordingly, it is not too much of an exaggeration to say that credit statements generated from these reporting systems can be misleading in their reflections of an individual's true creditworthiness.

The delay in obtaining results is not the only challenge in analysis. Often, personally identifiable information of individuals are not exact or up to date. For example, someone may use street address with “101 Main Street” for one credit card, but use “101 Main St.” for her mortgage account or, as is quite common, change phone number. Credit events from one financial institution may have an updated phone number while credit events from another financial institution may have an outdated phone number. Such irregularities and outdated personally identifiable information pose a unique challenge to a data analyst, such as to accurately resolve credit events of a user from multiple sources based on personally identifying information that doesn't match between those events.

Credit data storage and analysis systems may implement data models where rigorous ETL processes are positioned near the data ingestion in order to standardize incoming data, where ETL processes involve restructuring, transformation, and interpretation. As will be described, early interpretation can mean early introduction of defects into the data flow, and the extended life cycle of each defect before the data consumption provides ample propagation opportunity for the defect. Additionally, as such systems update ETL processes for each new incoming data with new data structures, significant software and engineering efforts are expended to incorporate the new incoming data. Eventually, marginal effort to maintain the upstream interpretation can overwhelm such system. Also, ETL processes may transform the original data or create a substantially similar copy of the original data. When some defect in the interpretation process is found after the original data is transformed into a standard form, there can be a severe loss of information. Alternatively, when original event data is substantially copied, there is a waste of storage space and severe impact of processing capabilities of the larger data set. In various implementations of credit data systems, one or more of the following technical problems or challenges may be encountered:

The data integration approaches, such as data warehouses and data marts, attempt to extract meaningful data items from incoming data and transform them into a standardized target data structure;

As the number of data sources grows, the software required to transform data from multiple types of sources also grows in size and complexity;

The marginal effort of bringing a new data source becomes larger and larger as incorporating new data sources and formats requires existing software to be modified;

Incorporating new data sources and types may cause the target data structure to be modified, requiring conversion of existing data from one format to another;

The complexity of software modifications and data conversions can lead to defects. If the defects go unnoticed for a long period of time, significant effort and cost must be expended to undo the effects of the defects through further software modifications and data conversions, and the cycle can go on;

These data integration approaches may have high defect leverage because they try to interpret and transform data closer to the point of ingestion.

Therefore, such credit data systems (and other high volume data analysis systems) are technically challenged at least in their lack of agility, adaptability, accuracy, reliability, interoperability, defect management and storage optimization.

### Definitions

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. Thus, the definitions below do not limit the meaning of these terms, but only provide exemplary definitions.

The terms “user,” “individual,” “consumer,” and “customer” should be interpreted to include single persons, as well as groups of users, such as, for example, married couples or domestic partners, organizations, groups, and business entities. Additionally, the terms may be used interchangeably. In some embodiments, the terms refer to a computing device of a user rather than, or in addition to, an actual human operator of the computing device.

Personally identifiable information (also referred to herein as “PII”) includes any information regarding a user that alone may be used to uniquely identify a particular user to third parties. Depending on the embodiment, and on the combination of user data that might be provided to a third party, PII may include first and/or last name, middle name, address, email address, social security number, IP address, passport number, vehicle registration plate number, credit card numbers, date of birth, and/or telephone number for home/work/mobile. In some embodiments user IDs that would be very difficult to associate with particular users might still be considered PII, such as if the IDs are unique to corresponding users. For example, Facebook's digital IDs of users may be considered PII to Facebook and to third parties.

User Input (also referred to as “Input”) generally refers to any type of input provided by a user that is intended to be received and/or stored by one or more computing devices, to cause an update to data that is displayed, and/or to cause an update to the way that data is displayed. Non-limiting examples of such user input include keyboard inputs, mouse inputs, digital pen inputs, voice inputs, finger touch inputs (e.g., via touch sensitive display), gesture inputs (e.g., hand movements, finger movements, arm movements, movements of any other appendage, and/or body movements), and/or the like.

Credit data generally refers to user data that is collected and maintained by one or more credit bureaus (e.g., Experian, TransUnion, and Equifax), such as data that affects creditworthiness of a consumer. Credit data may include transactional or state data, including but not limited to, credit inquiries, mortgage payments, loan situations, bank accounts, daily transactions, number of credit cards, utility payments, etc. Depending on the implementation (and possibly regulations of the region in which the credit data is stored and/or accessed), some or all of credit data can be subject to regulatory requirements that limit, for example, sharing of credit data to requesting entities based on the Fair Credit Reporting Act (FCRA) regulations in the United States and/or other similar federal regulations. “Regulated data,” as used herein, often refers to credit data as an example of such regulated data. However, regulated data may include other types of data, such as HIPPA regulated medical data. Credit data can describe each user data item associated with a user, e.g., an account balance, account transactions, or any combination of the user's data items.

Credit file and credit report each generally refer to a collection of credit data associated with a user, such as may be provided to the user, to a requesting entity that the user has authorized to access the user's credit data, or to a requesting entity that has a permissible purpose (e.g., under the FCRA) to access the users credit data without the user's authorization.

Credit Event (or “event”) generally refers to information associated with an event that is reported by an institution (including a bank, a credit card provider, or other financial institutions) to one or more credit bureaus and/or the credit data system discussed herein. Credit events may include, for example, information associated with a payment, purchase, bill payment due date, bank transaction, credit inquiries, and/or any other event that may be reported to a credit bureau. Typically one credit event is associated with one single user. For example, a credit event may be a specific transaction, such as details regarding purchase of a particular product (e.g., Target, $12.53, grocery, etc.) or a credit event may be information associated with a credit line (e.g., Citi credit card, $458 balance, $29 minimum payment, $1000 credit limit, etc. Generally, a credit event is associated with one or more unique identifies, wherein each unique identity includes one or more unique identifiers associated with a particular user (e.g., a consumer). For example, each identifier may include one or more pieces of PII of the user, such as all or some portion of a user's name, physical address, social security number (“SSN”), bank account identifier, email address, phone number, national ID (e.g., passports or driver's license), etc.

Inverted PID refers to a unique identifier that is assigned to a particular user to form a one-to-one relationship. An inverted PID can be associated with an identifier of the user, such as a particular PII (e.g., an SSN of “555-55-5555”) or a combination of identifiers (e.g., a name of “John Smith” and an address of “100 Connecticut Ave”) to form a one-to-many relationships (between the PID and each of multiple combinations of identifiers associated with a user). When an event data includes an identifier or combination of identifiers associated with a particular inverted PID, the particular inverted PID may be associated with (referred to as “stamped” herein) to the event data. Accordingly, a system may use inverted PIDs and their associated identity information to identify event data associated with a particular user based on multiple combinations of user identifiers included in the event data.

### Credit Data Systems

Credit data associated with a user is often requested and considered by entities such as lenders, credit card providers, banks, car dealers, brokers, etc. when determining whether to extend credit to the user, whether to allow the user to open an account, whether to rent to the user, and/or in making decisions regarding many other relationships or transactions in which credit worthiness may be factor. An entity requesting credit data, which may include a request for a credit report or a credit score, may submit a credit inquiry to a credit bureau or credit reseller. The credit report or a credit score may be determined at least based on analyzing and computing credit data associated with the user's bank accounts, daily transactions, number of credit cards, loan situations, etc. Furthermore, a previous inquiry from a different entity may also affect the user's credit report or credit score.

Entities (e.g., financial institutions) may also wish to acquire a user's most updated credit data (e.g., credit score and/or credit report) in order to make a better decision whether to extend credit to the user. However, there may be substantial delay in generating a new credit report or credit score. In some cases, the credit bureau may only update a user's credit report or score once a month. As described above, the substantial delay may be caused by the sheer volume of data a credit bureau needs to collect, analyze and compute in order to generate a credit report or credit score. The process of collecting credit data that may affect an user's creditworthiness, such as the user's credit score, from credit events is generally referred to herein as “data ingestion.” Credit data systems may perform data ingestion using lateral data flow from system to system, such as by using a batch ETL process (e.g., as briefly discussed above). In an ETL data ingestion system, credit events associated with multiple users may be transmitted from different data sources to a Database (Online System), such as one or more relational databases. The online system may extract, transform and load raw data associated with different users from the different data sources. The online system can then normalize, edit, and write the raw data across multiple tables in the first relational database. As the online system inserts data into the database, it must match the credit data with the identifying data about consumers in order to link the data to the correct consumer records. When new data comes in, the online system needs to repeat the process and update the multiple tables in the first relational database. Because incoming data, such as names, addresses, etc. often contain errors, does not conform to established data structures, are incomplete, and/or have other data quality or integrity issues, it is possible that new data would initiate reevaluation of certain previously determined data linkages. In such cases, the online system may unlink and relink credit data to new and/or historical consumer records.

In some cases, certain event data should be excluded from a credit data store, such as if there is a detected error in the data file provided by the data source, or a defect in the credit data system software that may have incorrectly processed historical data. For example, an unintelligent credit data system that stores data in the date format MM/DD/YYYY may accept incoming data from a data source using the date format DD/MM/YY, which may introduce error in a user's creditworthiness calculation. Alternatively, such data may cause the credit data system to reject the data altogether, which may result in incomplete and/or inaccurate calculation of a user's creditworthiness. Worse yet, where the erroneous data has already been consumed by the credit data system to produce a user's (albeit inaccurate) creditworthiness metric, the credit data system may need to address complexities of not only excluding the erroneous data, but also unwinding all the effects of the erroneous data. Failure to do so may leave the online database in an inconsistent or inaccurate state.

Such incremental processing logic makes the data ingestion process complex, error-prone, and slow. In ETL implementations, the online system can send data to a batch system including a second database. The batch system may then extract, transform, and load the data associated with credit attributes of a user to generate credit scores and analytical reports for promotional and account review purposes. Due to the time it takes to extract, transform and load data into the batch system, the credit scores and analytical reports may lag the online system by hours or even days. The lagging batch system, in the event of an update to user identifying data, may continue to reflect old and potentially inaccurate user identifying data such that linkages between incoming credit data and the user data may be broken, thereby providing inaccurate credit data until the linkages are corrected and propagated to the batch system.

### Overview of Improved Credit Data System

The present disclosure describes a faster and more efficient credit data system directed to address the above noted technical problems. The credit data system may perform sequential processing of a collection of heterogeneous events, simultaneous creation of a credit state and credit attributes for analytics, a batch indexing process, and/or creation of credit profiles in real-time by merging credit state with real-time events, each of which is described in further detail below.

A batch indexing process may more efficiently associate credit events to correct users at a massive scale by efficiently “clustering” unique identities by first reducing dimensionality of the original credit events, identifying false positives, and providing a whole validated set of unique identities that can be associated with a user. By using inventive combination of processes in a particular order, the credit data system solves the particular problem of efficiently identifying credit events belonging to a particular user in efficiency by powers of magnitudes. Additionally, assignment of inverted PIDs allows for a new and more efficient data arrangement that the credit data system can utilize to provide requested credit data pertaining to a user faster by powers of magnitudes. The improved credit data system can generate various analytics of a user's activities and state (such as a credit report) based on up-to-date credit events associated with that user.

The credit data system may implement a lazy data interpretation, in which the system does not alter the heterogeneous incoming data from multiple data sources, but annotates or tags the data without performing ETL processes on the data. By performing only minimal processing near data ingestion, the credit system minimizes software size and complexity near the data ingestion, thereby greatly reducing defect formation and issues with defect management. Additionally, by doing away with ETL processing and preserving data in their original heterogeneous form, the system can accept any type of data without losing valuable information. Domain categorization and domain vocabulary annotation provides for new data structures that allows for late positioning of the interpretation components, such as parsers. The late positioning of parsers improves over the existing systems by reducing overall defect impact on the system and allowing for easy addition or adaptation of the parsers.

While some embodiments of a credit data system or other similarly named systems are discussed herein with reference to various features and advantages, any of the discussed features and advantages may be combined or separated in the additional limitations of a credit data system.

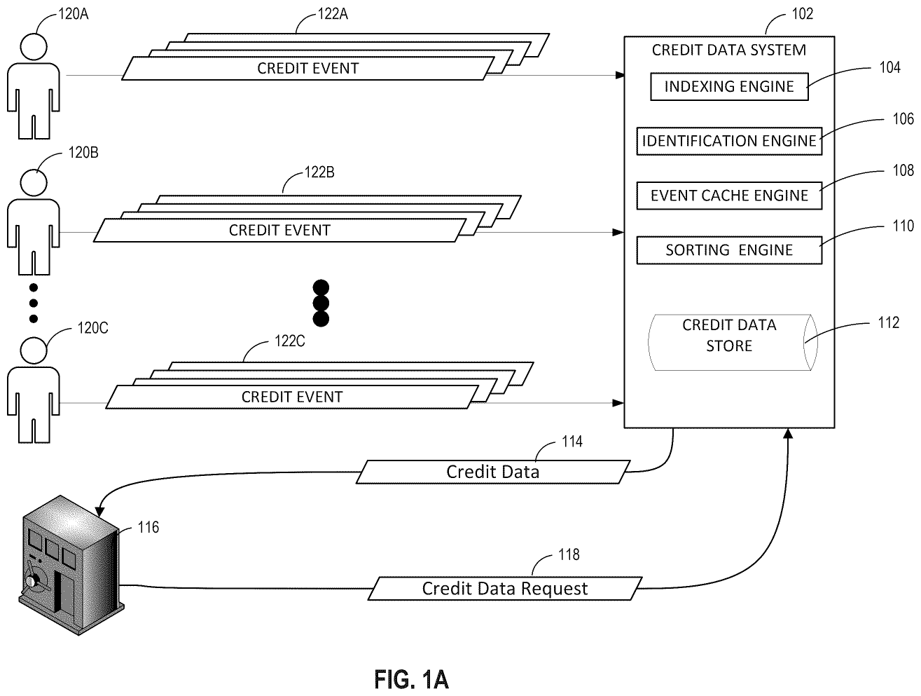

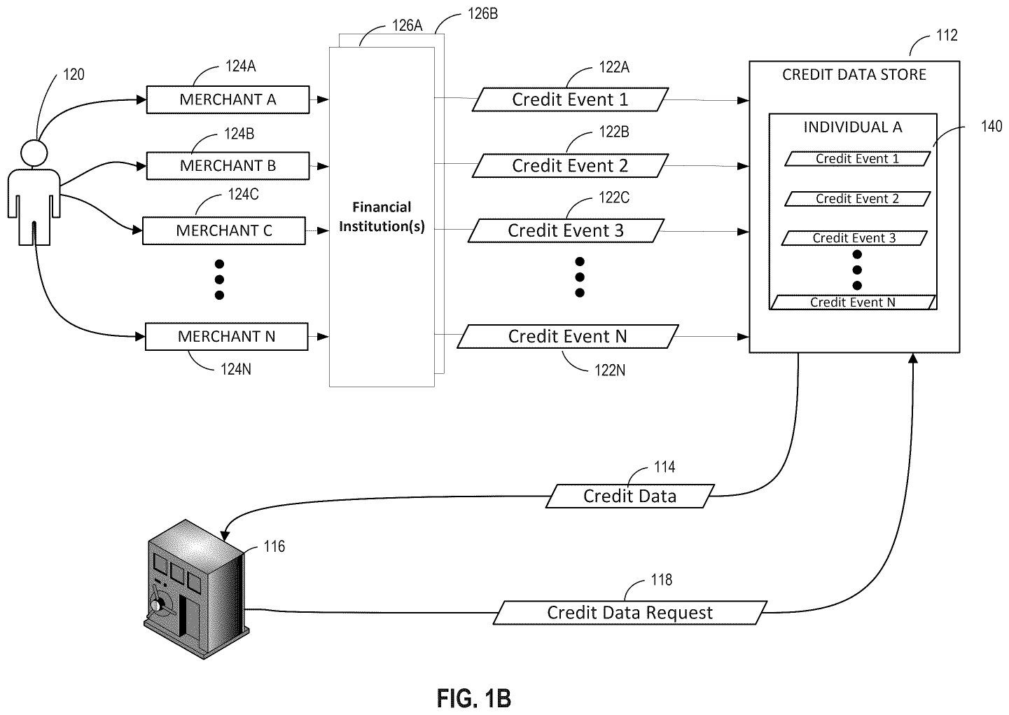

FIG. 1A illustrates an example credit data system 102 of the present disclosure, which may be implemented by a credit bureau or authorized agent of a credit bureau. In FIG. 1A, the credit data system 102 receives credit events 122A-122C associated with different users 120A-120C. The credit data system 102 may include components such as an indexing engine 104, an identification engine 106, an event cache engine 108, a sorting engine 110, and/or a credit data store 112. As will be described further in detail, the credit data system 102 can efficiently match specific credit events to appropriate corresponding users. The credit data system 102 can store the credit events 122A-122C, credit data 114, and/or associations between the different users and the credit events 122A-122C or credit data 114 in the credit data store 112, which may be a credit database of a credit bureau. In some embodiments, the credit database may be spread across multiple databases and/or multiple credit data stores 112. Thus, the credit data ingestion and storage processes, components, architecture, etc. discussed herein may be used to largely replace existing credit data storage systems, such as batch systems. In response to receiving a credit inquiry request from an external entity 116 (e.g., a financial institution, lender, potential landlord, etc.), the credit data system 102 can quickly generate any requested credit data 118 (e.g. a particular transaction, credit report, credit score, custom credit attributes for the particular requesting entity, etc.) based on updated credit event data of the target user.

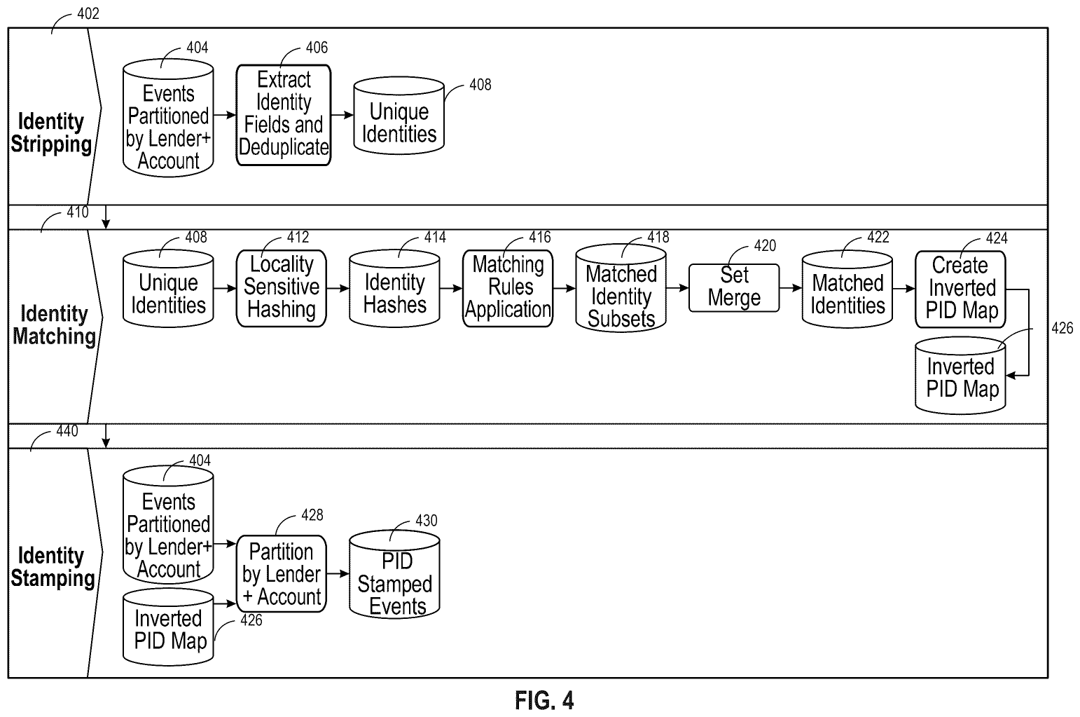

Additionally, the credit data system may implement a batch indexing process. The incorporation of the batch indexing process may eliminate the need to ETL data from different credit events to conform to a particular database or data structures and, therefore, may reduce or even eliminate bottlenecks associated with ETL of the credit events. The batch indexing process, as will be described in further detail throughout this application, utilizes the indexing engine 104, identification engine 106, event cache engine 108, sorting engine 110, and/or credit data store 112, which are components of the credit data system 102. The indexing engine 104 can assign hash values to unique identities (further detailed with respect to FIG. 4-10) to facilitate “clustering” of similar unique identities. The identification engine 106 can apply matching rules to resolve any issues with the “clustered” unique identities, thereby generating a subset containing only the validated unique identities associated with a user. The sorting engine 110 can merge the subsets into groups of unique identities associated with a same user. The event cache engine 108 can generate an inverted personal identifier (“inverted PID”) and associate each unique identity in a group with the inverted PID. The credit data system 102 can store the association between inverted PIDs and unique identities as an inverted PID map in the credit data store 112 or in any other accessible data stores. Using the inverted PID map, the credit data system 102 can then stamp credit events containing any of the unique identities in a group with the user-associated inverted PID. The credit data system 102 may store the stamp associations 140 related to the credit events 122A-122N pertaining to a user in a flat file or a database. Each component and their inner workings will are further detailed with respect to FIG. 4-10.

### Unaltered Processing of Heterogeneous Credit Events

FIG. 1B illustrates an example generation, flow, and storage of heterogeneous credit event, according to some embodiments. A user 120 conducts transactions with one or more business entities 124A-124N (such as merchants). The transactions may include purchasing, selling, borrowing, loaning, or the like and the transactions may generate credit events. For example, a user 120 purchasing an item on credit using a credit card generates a credit transaction data that is collected by financial institutions 126A-126B (such as VISA, Mastercard, American Express, banks, mortgagers, etc.). The financial institutions 126A-B may share such transactions with a credit data store 112 as credit events 122A-122N.

Each credit event 122A-122N can contain one or more unique identities that associate the credit event 122A-122N with a particular user 120 who generated the credit event 122A-122N. A unique identity may include various user identifying information, such as a name (first, middle, last, and/or full name), address, social security number (“SSN”), bank account information, email address, phone number, national ID (passport or driver's license), etc. The unique identities can also include partial names, partial address, partial phone number, partial national ID, etc. When the financial institutions 126A-126B provide credit events 122A-122N for collection and analysis by a credit data system, generally the credit events can be recognized as being associated with a particular user through a combination of user identifying information. For example, there may be multiple people who share same first name and last name (consider “James Smith”) and thus first name and last name may be overly inclusive of other users' credit events. However, combinations of user identifying information, such as full name plus phone number, can provide satisfactory identification. While each financial institution 126 may provide credit events 122A-122N in different formats, the credit events are likely to include user identifying information or combinations of user identifying information that can be used to associate to which user the credit event should be associated. Such user identifying information or combinations of user identifying information forms a unique identity of the user. Accordingly, multiple unique identities may be associated with a particular user.

The credit data system can work with heterogeneous credit events 122A-122N having different data structure and providing different unique identity along with the credit events 122A-122N. For example, a credit event from a mortgager financial institution may include SSN and national ID, whereas a credit event from VISA may include name and address, but not SSN or national ID. The credit data system, instead of performing ETL on the credit events 122A-122N to standardize the credit events 122A-122N for storage on the credit data store 112, can perform an batch indexing process (as later described in detail with respect to FIGS. 4-10) to come up with an inverted PID for a set of unique identities likely to be associated with the user 120. The inverted PID can be assigned to the credit events 122A-122N.

As will be described in further detail, the batch indexing process reduces or eliminates significant computing resource overhead associated with ETL of heterogeneous formats, significantly cuts down processing overhead. Additionally, assigning an inverted PID to a credit event is beneficial in that, once correct inverted PID is assigned to a credit event, the credit data system 120 no longer needs to manage credit events based on the contained unique identities. In other words, once the credit data system 120 has identified a user associated with a credit event, it does not need to perform searching operation to find unique identities in credit events 122A-122N but simply look for the credit events 122A-122N assigned user's inverted PID. For example, in response to receiving a credit data request 118 from an external entity 116 (such as a financial institution, a lender, potential landlord, etc.), the credit data system with the batch indexing process can quickly compile a list of credit events of a user 120 with the user's inverted PID and provide any requested credit data 114 almost instantaneously.

### Example of Sequential Processing of Collection of Heterogeneous Events

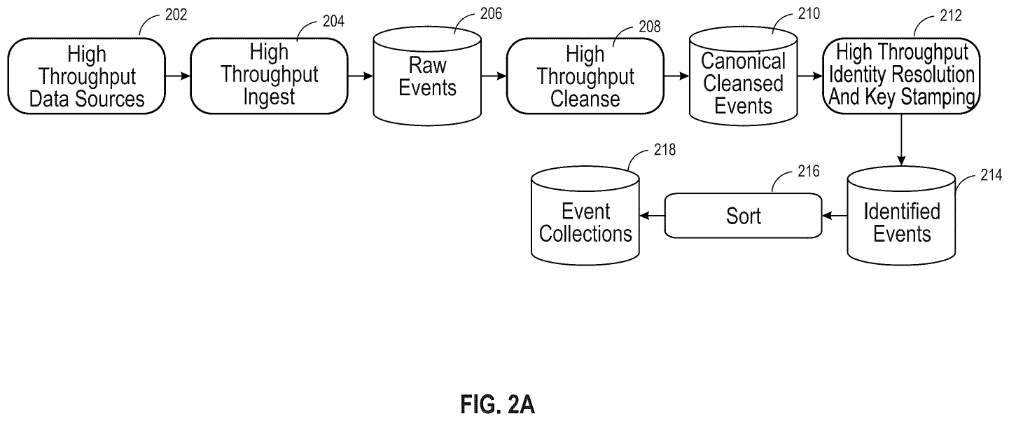

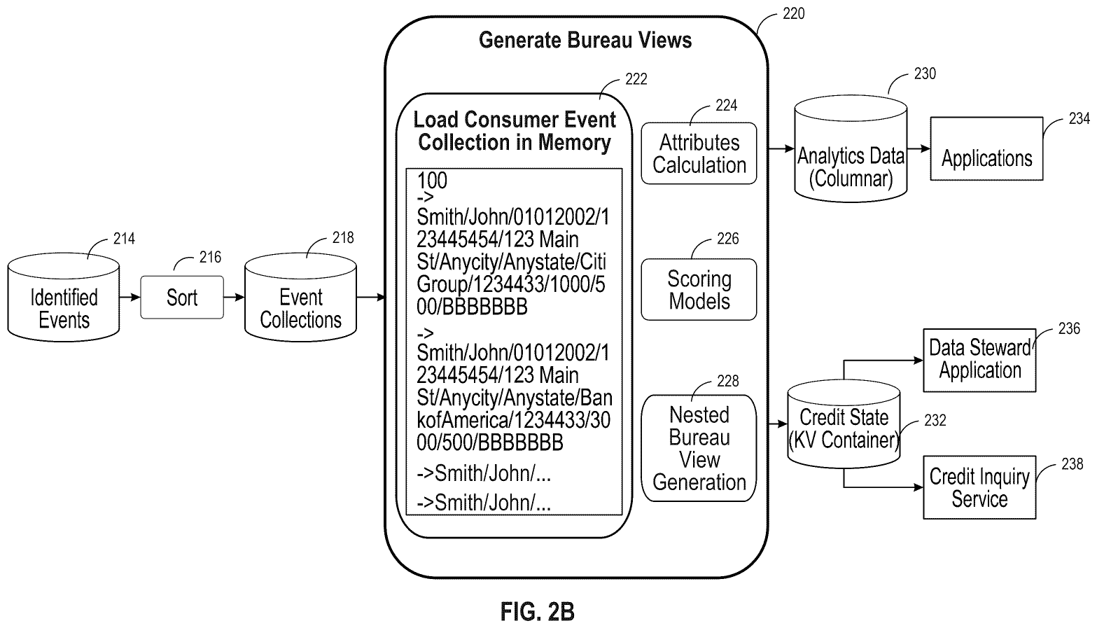

FIGS. 2A-2B illustrates an example of sequential processing of a collection of heterogeneous events. The credit data system can receive raw credit events from high throughput data sources 202 through a high throughput ingestion process 204. The credit data system can then store the raw credit events in a data store 206. The credit data system can conduct a high throughput cleanse process 208 on the raw credit events. The credit data system can then generate and store canonical cleansed events in a data store 210. The credit data system can conduct a high throughput identify resolution and key stamping process 212. The credit data system can store the identified events with key stamping in a data store 214. The identified credit events can then be sorted in process 216 and stored into an event collection data store 218.

The credit data system can also generate bureau views in process 220. In the process 220, the credit data system can load a user event collection (identified events in the data store 214 that may have optionally been sorted by the sorting process 216) associated with a user in memory at process 222 from the event collections data store 218. The system can then calculate attributes 224, score models 226, and generate nested bureau view 228. The credit data system can then store the attribution calculation in an analytics data (columnar) store 230. The analytics data can be used in applications 234 to generate a credit score for the user. The nested bureau view can be stored in credit state (KV Container) data store 232. The data in the credit state data store can be used in data steward application process 236 and credit inquiry service 238.

During the sequential processing, the credit events may remain in the same state as they are transmitted to the credit data system by the financial institutions. Financial data may also remain the same.

### Example of Simultaneous Creation of a Credit State and Credit Attributes for Analytics

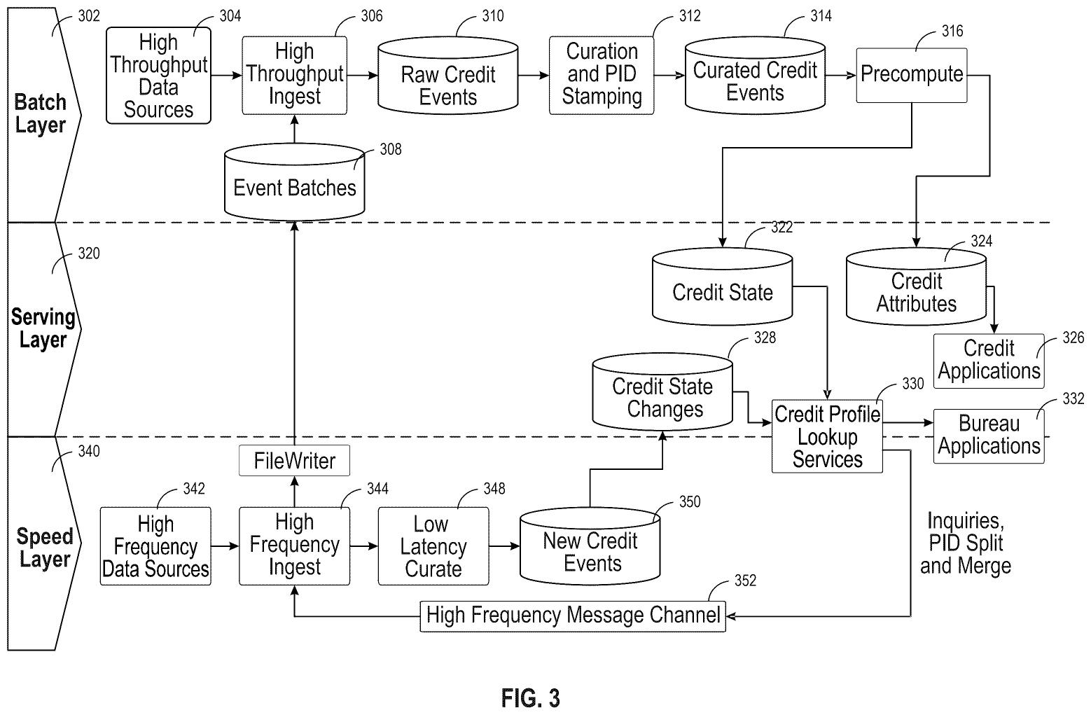

FIG. 3 illustrates an example credit data structure of simultaneous creation of the credit state and the credit attributes for analytics. The data structure 300 may virtually be divided to three interactive layers: a batch layer 302, a serving layer 320, and a speed layer 340. In the batch layer 302, high throughput data sources 304 may transmit raw credit events to a data store 310 through a high throughput ingestion process 306. The credit data system can curate and PID stamp 312 the raw credit events and store the curated credit events in a data store 314. The credit data system can then precompute 316 the curated credit events associated with each user to generate a credit state and store each user's credit state in a data store 322. The credit data system can store all the credit attributes associated with each user in a data store 324. The credit attributes associated with a user may then be access by various credit applications 326.

In the speed layer 340, various high frequency data sources 342 may transmit new credit events to the credit data system through a high frequency ingestion process 344. The credit data system can conduct a low latency curation process 348 and then store the new credit events associated with various users in a data store 350. The new credit events associated with a user may cause changes in the user's credit state. The new credit state may be stored in a data store 328. The credit data system can then conduct a credit profile lookup service process 330 to look for a watermark to find the stored credit state associated with the user. In some embodiments, the event cache engine is configured to allow even very recent credit events that aren't yet recorded to the user's full credit state to be included in credit attributes that are provided to third party requesters. For example, while event data is being added to credit data store (e.g., which may take hours or event days to complete), the event stored in the new credit events data store 350 may store the most recent credit events and be accessed when credit inquiries are received. Thus, requested reports/scoring may include credit events within milliseconds of receiving the event from a creditor.

The credit data system can use various bureau applications 332 to calculate a credit score or generate a credit report for the user based on the new credit state. Additionally, the credit data system can send instructions the high frequency ingestion process 344 via a high frequency message channel 352. The new credit events can be transmitted by the high frequency ingestion process 344 again to a file writer process 346. The credit data system can then store the new credit events into an event batch 308. The new credit events can then be stored to the data store 310 through the high throughput ingestion process 306.

The credit data system can store credit events in its original form, generate a credit state based on the credit events and calculate attributes for a user. When a new credit event is transmitted from a financial institution, or an error is detected in an existing credit event by a financial institution, the credit data system can conduct a credit profile lookup service to make changes in the credit state or merge the credit state with real-time events. The credit data system can generate an updated credit profile based on the updated credit state.

The simultaneous creation of the credit state and the credit attributes can monitor changes in a user's credit state and update credit attributes when changes are detected. The changes in the user's credit state may be caused by a new credit event or an error detected in an existing credit event. The credit events may remain the same at least partly because the credit data system do not extract, transform and load data into database. If there is an invalid event detected later by the credit data system, the credit data system can simply exclude the invalid event from future creation. Thus, real-time reporting of events can be reflected on a user's profile within minutes with the help of the credit data system.

### Example of Batch Indexing Process

FIG. 4 illustrates a batch indexing process, which includes processes of: identity stripping 402, identity matching 410, and identity stamping 440, according to some embodiments. The batch indexing process can be an especially powerful process in identifying and grouping disparate unique identities of the user (e.g., a credit event from VISA with an outdated phone number can be grouped with a credit event from American Express with an updated phone number). One benefit of the grouping disparate identities is that a user's credit data can be accurate and complete. The batch indexing process can make the credit data system far more efficient and responsive.

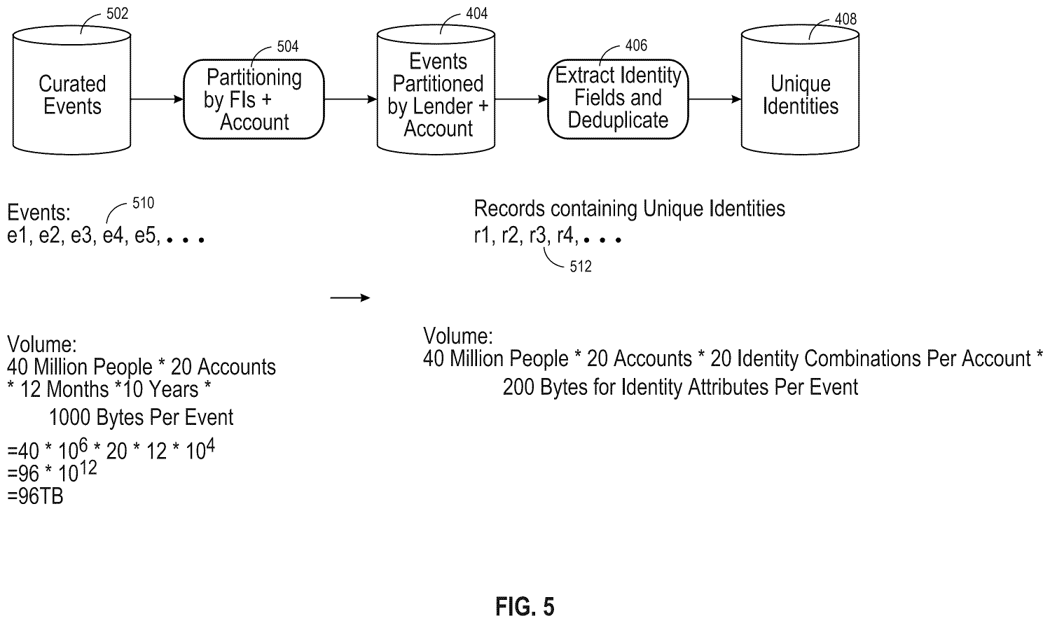

The identity stripping process 402 extracts identity fields (e.g., SSN, national ID, phone number, email, etc.) from credit events. The credit data system can partition 404 credit events by different financial institutions (e.g., credit card providers or lenders) and/or accounts. The credit data system can then extract 406 identity fields from the partitioned credit events without modifying the credit events. The identity stripping process 402 may include a specialized extraction process for each different credit event format provided by different financial institutions. In some embodiments, the identity stripping process 402 may conduct a deduplication process 406 to remove same or substantially similar identity fields before generating unique identity, which may be a combination of identity fields, associated with the credit event. This process will be further detailed with respect to FIG. 5.

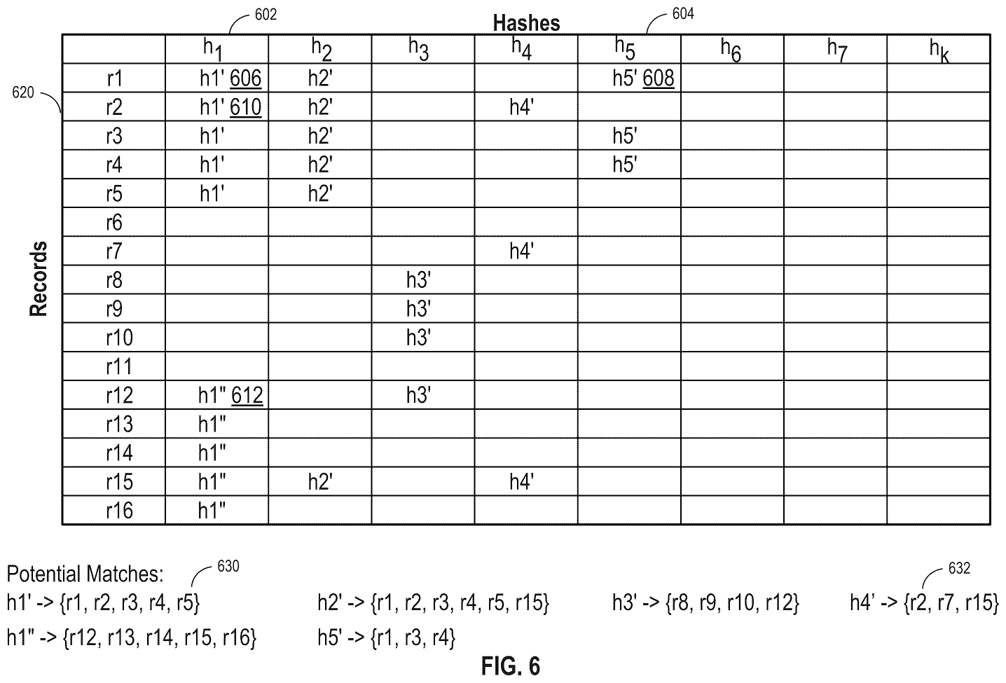

In the identity matching process 410, the credit data system can perform a process that reduces dimensionality of the unique identities determined in the identity stripping process 402. For example, a locality sensitive hashing 412 process can be such a process. The locality sensitive hashing process, depending on design of the hashing process, can calculate hash values (e.g., identity hashes 414) that have increased or decreased collision probability based on similarity of the original hash keys (e.g., unique identities 408). For example, a well-designed hashing process can take disparate but similar unique identifiers, such as “John Smith, 1983 Aug. 24, 92833-2983” and “Jonathan Smith, 1983 Aug. 24, 92833” (full name, birthdate, and ZIP codes) and digest the disparate but similar unique identifiers into a same hash value. Based on the sharing of the common hash value, the two unique identities can be grouped into a set as potentially matching unique identities associated to a user (the details of the hash-based grouping process will be further detailed with respect to FIG. 6).

However, because hash functions can result in unintended collisions, the hash-based sets can contain false positives (e.g., wrongly associating some credit events not associated with a user to the user. For example, one of John's unique identities may have a same hash value with one of Jane's unique identity and, after hash value association, may get grouped into a same set of unique identities associated with Jane). The credit data system can apply a matching rule application 416 on the sets of unique identities to remove the false positive unique identities from the sets. Various matching rules can be designed to optimize the chance of detecting the false positives. An example match rule can be “only exact match of national ID,” which would remove, from a set of unique identities associated with a user, unique identities that do not include the national ID on file. Another match rule may be “minimum match on both name and ZIP code,” where minimum may be determined based on a calculated score of the match on both name and ZIP code compared against the minimum threshold score. Once false positives are removed from each set, the resulting matched identity subsets 418 contain only the unique identities that are validated.

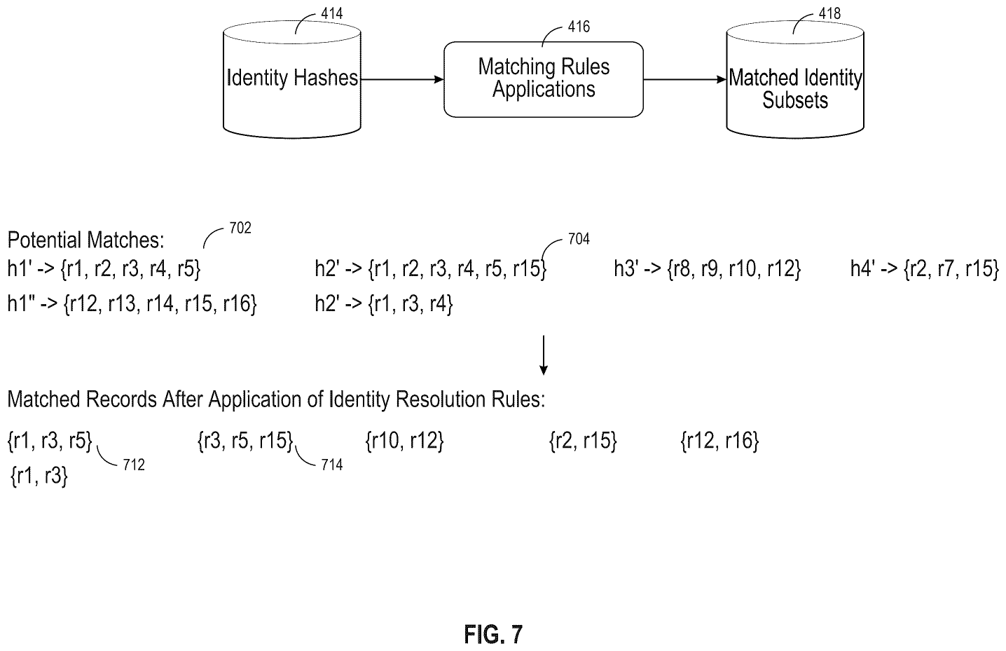

In some embodiments, the match rules may be designed with trustworthiness of each user identifier in mind. For example, driver's license number from Department of Motor Vehicles can be associated with high confidence level and may not require much beyond inspecting the driver's license numbers for an exact match. On the other hand, a ZIP code provides for lower confidence level. Also, the match rules may be designed to take into account history associated with a particular record. If the record comes from an established bank account having a long history, the match rule may not need to apply strict scrutiny. On the other hand, if the record comes from a newly opened account, a stricter match rule may be required to remove false positives (e.g., identify records in a set that are likely associated with another user). This process will be further detailed with respect to FIG. 7. The match rules may be applied to some or all of the sets. Similarly, some or all of the match rules may be applied to a set.

The subsets 418 of unique identities can then be merged with other subsets containing other unique identities of the user. Each subset 418 contain only the unique identities correctly identifying a user. However, the subsets 418, due to possible false negatives from the dimensionality reducing process, are not guaranteed to digest into a same hash value. Accordingly, some unique identity associated with a user may, when grouped based on hash values, be put in disparate subsets 418. With set merging 420 process, when subsets common unique identities, the credit data system can merge the two subsets into one group (e.g., matched identities 422) containing all the unique identities associated with a particular user.

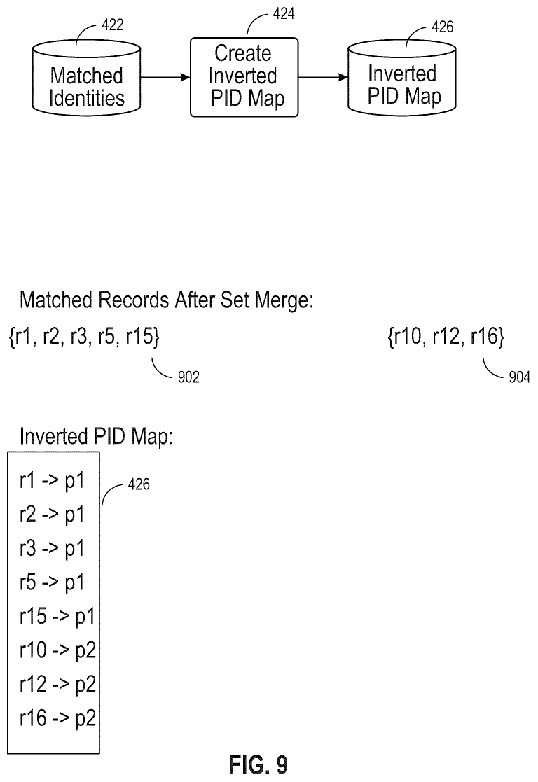

The credit data system can then assign an inverted PID to each unique identity in the merged group. From the assignments, the credit data system can then create 424 an inverted PID map 426 where each inverted PID is associated with multiple unique identities in the group associated with a particular user. This process will be further detailed with respect to FIG. 9.

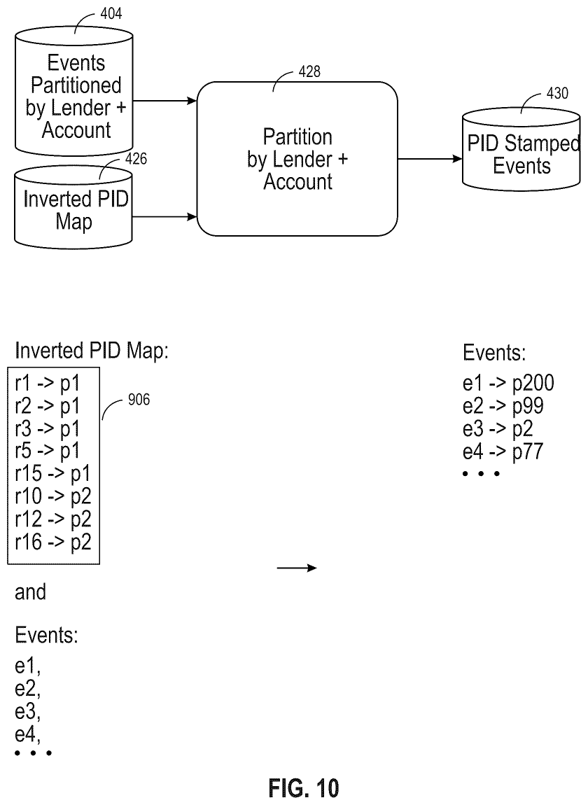

In the example identity stamping process 440, the inverted PID map 426 may be used to stamp the partitioned credit events 404 to generate PID stamped credit events 430. In some embodiments, the inverted PID stamping leaves the credit events associated with the inverted PID unaltered. This process will be further detailed with respect to FIG. 10.

### Example of Identity Stripping

FIG. 5 illustrates an example of an identity stripping process, according to some embodiments. In some embodiments, the credit data system may “curate” heterogeneous credit events 510 (e.g., e1, e2, e3, e4, e5 . . . ) received from various financial institutions. “Curation” may be considered as a process of fixing obvious quality issues. For example, a street address may be “100 Main Street” or “100Main St.” The credit data system can recognize the obvious quality issue of having no space between the street number and street name, and/or modify “St.” to read “Street,” or vice versa. The curation process can smartly fix some identified quality issues while not fixing some other identified quality issues. For example, while an address above can be a candidate for curation, curating user names may be less than ideal. Truncating, replacing, or otherwise modifying user names may cause more trouble than leaving the information whole. Accordingly, in some embodiments, the credit data system may selectably curate credit events 502.

The credit data system can partition credit events 504 by different financial institutions and/or accounts. The credit data system can extract 406 identity fields of the credit events and may optionally conduct a deduplication process to eliminate redundant identity fields. The credit data system may then generate unique identities based on the extracted identity fields. The identity stripping process starts with the credit events 510 and extracts unique identities 512. In the example of FIG. 5, credit events e1, e2, e3, e4, e5 . . . 510 may contain records: r1, r2, r3, r4 . . . 512. Records in turn, may contain some or all of a unique identity.

FIG. 5 describes the benefits of an identity stripping process. Where there are 40 million people each having 20 accounts generating credit events (each occupying 1000 bytes per event) over 10 years, there exist approximately 96 terabytes of credit event data. On the other hand, where there is same number of people having same number of accounts, only approximately 3.2 terabyte is occupied by identity attributes of the credit events. If correct association between credit events and a particular user can be made with the stripped unique identities 408 (which include 1/30 of the credit event data), a credit data system has significantly narrowed the universe of data that needs to be analyzed for association to the particular user. Therefore, the credit data system has already significantly reduced computational overhead of the next identity matching process.

### Example of Identity Matching: Locality Sensitive Hashing

FIG. 6 illustrates an example process of reducing dimensionality of data using hash algorithms, according to some embodiments. The records containing unique identities (r1-r16) from the identity stripping process are listed on the rows and different hash functions (h1-hk) are listed on the columns. The tabular presentation having rows and columns are for illustrative purpose only and the process may be implemented in any reasonably applicable methods. Additionally, the rate of collision (i.e., applying a hash function on disparate records resulting in same hash values) in the illustration does not reflect the likelihood of collision when real credit events are concerned.

Multiple hash functions (e.g., h1 602, h5 604, etc.) can be applied on each records (e.g., r1-r16) to generate hash values (e.g., h1′ 606, h5′ 608, h1′ 610, h1″ 612, etc.). Here, each row-column combination represents a hash function of the column being applied on a record of the row to generate a hash value of the row-column combination. For example, has function h1 602 applied on unique identity r2 620 generates hash value h1′ 610.

In some embodiments, each hash function can be designed to control a probability of collision for a given record. For example, h1 602 may be a hash function focusing on finding similar first names by causing collision with other records having similar first names. On the other hand, h5 604 may be a hash function focusing on SSN, where likelihood of collision is lower than the hash function focusing on finding similar first names h1. Various hash functions may be designed to better control collision likelihood. One of the benefits of the disclosed credit data system is its capacity to substitute or supplement various hash functions. The credit data system does not require a particular type of hash function, but allows the user (e.g., a data engineer) to experiment with and engineer to improve the overall system by simply interfacing different hash function. This advantage can be significant. For example, when the data engineer wants to migrate the credit data system into another country using another character set, say Chinese or Korean, the data engineer can replace hashing functions directed toward English alphabet to hashing functions that provide better results for Chinese or Korean characters. Also, where national ID is of different format, such as Korea using 12 digit numbers for SSN as opposed to 9 digits SSN in US, a hash function better suited for 12 digit number can replace the 9 digit hash function.

While FIG. 6 illustrates records r1-r16 without modification, some embodiments may pre-process the records to come up with modified records that are better suited for a given hash function. For example, a first name in a record may be concatenated with a last name in the record to form a temporary record for use by a hash function specializing in such modified record. Another example may be truncating 9 SSN number to last 4 digits before applying a hash function. Similarly, a user may modify records to better control collision likelihood and the results.

FIG. 6 illustrates hash function h1 generating two different hash values, h1′ 606 and 610 and h1″ 612. The records {r1, r2, r3, r4, and r5} are associated with hash value h1′ 606 while records {r12, r13, r14, r15, and r16} are associated with hash value h1″ 612. Based on association with a particular hash value, records can be grouped into sets. For example, the illustration shows hash value h1′ group 630 and hash value h1″ group 632 containing the associated records. Similarly, FIG. 6 identifies and presents a total of six sets of records based on common hash values associated with the records. As hash values h1′ 606 and h5′ 608 show for record r1, each record may be associated with multiple hash values each for each hash function.

As described with respect to FIG. 4, records having common hash value may be grouped (“clustered”) into a set. For example, the records {r1, r2, r3, r4, r5} share a common hash value h1′ and are grouped into a set 630. Similarly, records {r2, r7, r15} share a common hash value of h4′ and are grouped into a set 632. As the two groups show, some of the records (for example, r2) may be grouped into more than one set, while some records are grouped into one set

Such hash value based grouping can be an incredibly fast grouping process that does not require much computing resources to execute. A hash function has low operational complexity and calculating hash values for massive amount of data can execute in a relatively short time. By grouping similar records together into sets, the process of identifying which records are associated with a particular user is greatly simplified. In a sense, the universe of all credit events that require association to the user has been narrowed to only the records in the sets.

However, as briefly mentioned with respect to FIG. 4, using hash functions and resulting hash values to group records can be less than ideal because it can contain false positives. In some embodiments, the resulting sets can carry “potential matches,” but the sets may contain records that have not yet been rigorously validated in their association with the user. For example, the set 630 of records having a particular hash value h1′, which are {r1, r2, r3, r4, r5} may contain records that is contained in the set 630 not by the virtue of having similar unique identity, but by the virtue of having a common hash value.

The credit data system then uses a rigorous identity resolution process (“matching rules applications”) to remove such false positives from each set.

### Example of Identity Matching: Matching Rules

FIG. 7 illustrates an example identity resolution process, according to some embodiments. After the grouping process described with respect to FIG. 6, the credit data system can apply one or more identity resolution rules (“matching rules”) on the sets of records remove false-positive records from the sets. Various matching rules can be designed to optimize the chance of detecting false positives. An example matching rule can be “only exact match of national ID,” which would remove, from a set of potentially matching records associated with a user, such as records that had same hash value which assigned them to a same set, but upon inspection by the matching rule, are found to have disparate national ID. The matching rules may be based on exact or similar match. For example, the matching rules may also include “a perfect match on national ID, a minimum match on national ID and surname, a perfect match on national ID and similar match on surname.”

In some embodiments, the matching rules may compute one or more confidence scores and compare against one or more associated thresholds. For example, a matching rule of “minimum match on both name and ZIP code” may have a threshold score that determines the minimum match and the matching rule may throw out a record having a computed score below the threshold value. The matching rules may inspect identifiers of records (e.g., names, national IDs, age, birthdate, etc.), format, length, or other properties and/or attributes of the records. Some examples include:
Content: reject unless national ID provides exact match.
Content: accept when there is a minimum match on national ID AND last name.
Content: accept when there is an exact match on national ID AND similar match on first name.
Format: reject when user identifying information (e.g., SSN) do not contain 9 digits.
Length: reject when user identifying information do not match length of an associated onfile user identifying information.
Content, format, and length: reject when driver's license do not start with “CA” AND followed by X number of digits.

The matching rules can also be any other combinations of such criteria.

The resulting subsets 418 after application of matching rules contain same or fewer records compared to the original sets. FIG. 7 illustrates the original sets (e.g., 702 and 704) after the hash value grouping process of FIG. 6 and the resulting subsets (e.g., 712 and 714) after the application of the matching rules. For example, in their respective order, sets associated with h1′, h2′, h3′, h4′, h1″, h2′ originally contained, respectively, 5, 6, 4, 3, 5, and 3 records. After the application of the matching rules, the resulting subsets contain, respectively, 3, 3, 2, 2, 2, and 2 records all of which were previously contained in the original sets. Using the matching rules boosts confidence that all the remaining records are associated with the user.

### Example of Identity Matching: Set Merging

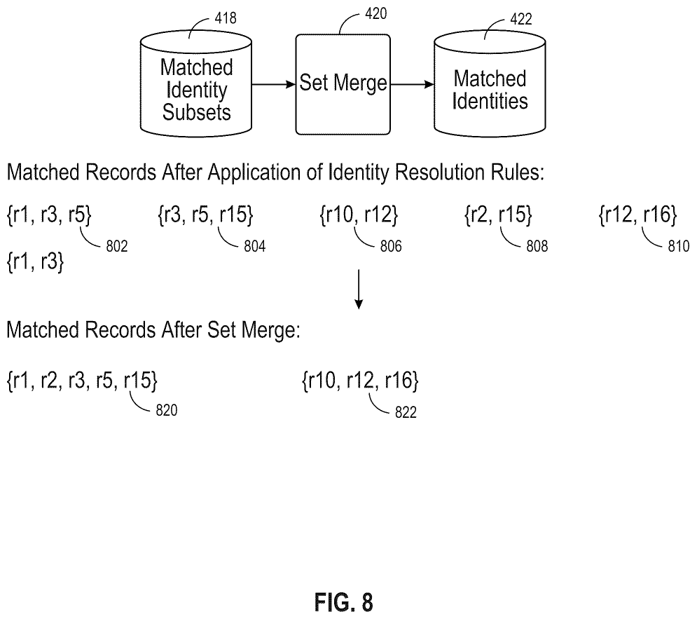

FIG. 8 illustrates an example set merging process, according to some embodiments. As discussed regarding existing systems, users sometimes change their personally identifiable information. An example was provided for a user who may not have updated his phone number associated with a mortgager. When the user has updated his phone number with a credit card provider, such as VISA, the reported credit events from the mortgager and VISA will contain different phone numbers while other information are the same. Such irregularities pose a unique challenge to a data analyst because, while both credit events should be associated with a particular user, the associated unique identities may be different and thus hashing function may not group them into a same set. When the records containing the unique identities are not grouped into a same set, the matching rules cannot fix the false negative (the records should have been put in a same set but were not). Thus, there exists a need to identify such irregular records generated by a same user and correctly associate the records to the user. Set merging process provides a solution that efficiently addresses the issue.

After the matching process of FIG. 7, each resulting subsets contain records that can be associated with a user with high confidence. In FIG. 8, there are 6 such subsets. The first subset 802 contains {r1, r3, r5} and the second subset 804 contains {r3, r5, r15}. The two subsets may have become separate subsets because all of the hash functions did not result in a common hash value.

A closer inspection of the first subset and the second subset reveals both subsets contain at least one common record, r3. Because each subset is associated with a unique user, all records in a same subset can also be associated with the same unique user. Logic dictates that if at least one common record exists in two disparate subsets that is associated with a unique user, the two disparate subsets should both be associated with the unique user and the two disparate subsets can be merged into a single group containing all the records in the two subsets. Therefore, based on the common record, r3, the first subset 802 and the second subset 804 are combined to yield an expanded group containing the records (i.e., {r1, r3, r5, r15} of the two subsets after the set merge process. Similarly, another subset 808 containing {r2, r15} can be merged into the expanded group based on the common record r15 to form a further expanded group 820 containing {r1, r2, r3, r5, r15}. Similarly, another group 822 containing {r10, r12, r16} can be formed based on other subsets 806 and 810. After the set merge process is complete, all the resulting groups will be records that are mutually exclusive. Each merged groups may contain all the records containing unique identities associated with a user.

### Example Set Merging Process

The above illustrated set merging can use various methods. Speed of merging sets may be important when sheer volume of records count in the millions or even billions. Here, one efficient grouping method is described.

The group algorithm first reduces each set into relationships of degree 2 (i.e., pairs). The algorithm then groups the relationships of degree 2 by the leftmost record. The algorithm then reverses or rotates the relationships of degree 2 to generate additional pairs. Then, the algorithm again groups the relationships of degree 2 by the leftmost record. Similarly, the algorithm repeats these processes until the all subsets are merged into final groups. Each final group can be associated with one user.

For illustrative purpose, subsets in FIG. 7 after matching rules are put through the algorithm. The subsets are:
{r1, r3, r5}, {r3, r5, r15}, {r10, r12}, {r2, r15}, {r12, r16}, and {r1, r3}.

Starting with the subsets, pairs of records (i.e., reducing each group into relationships of degree 2) are generated from the subsets. For example, the first subset containing {r1, r3, r5} can generate pairs:
(r1, r3)
(r3, r5)
(r1, r5)

The second subset containing {r3, r5, r15} can generate pairs:
(r3, r5)
(r5, r15)
(r3, r15)

The third subset containing {r10, r12} can generate pair:
(r10, r12)

The fourth subset containing {r2, r15} can generate pair:
(r2, r15)

The fifth subset containing {r12, r16} can generate pair:
(r12, r16)

The sixth subset containing {r1, r3} can generate pair:
(r1, r3)

The example merging process may list all the pairs. Because duplicates do not contain any additional information, the duplicates have been removed:
(r1, r3)
(r3, r5)
(r1, r5)
(r5, r15)
(r3, r15)
(r10, r12)
(r2, r15)
(r12, r16)

Rotate or reverse each pair:
(r1, r3)
(r3, r1)
(r3, r5)
(r5, r3)
(r1, r5)
(r5, r1)
(r5, r15)
(r15, r5)
(r3, r15)
(r15, r3)
(r10, r12)
(r12, r10)
(r2, r15)
(r15, r2)
(r12, r16)
(r16, r12)

Group by first record where the first record is common between the pairs:
{r1, r3, r5}
{r3, r1, r5, r15}
{r5, r3, r1, r15}—duplicate
{r15, r5, r3, r2}
{r10, r12}
{r12, r10, r16}
{r2, r15}
{r16, r12}

Another round of generating pairs. Duplicates are not shown:
(r1, r3)
(r3, r5)
(r1, r5)
(r3, r15)
(r1, r15)
(r5, r15)
(r15, r5)
(r15, r3)
(r15, r2)
(r5, r2)
(r3, r2)
(r10, r12)
(r12, r10)
(r12, r16)
(r10, r16)
(r2, r15)
(r16, r12)

Rotate or reverse each pair. Duplicates are not shown:
(r1, r3)
(r3, r5)
(r1, r5)
(r3, r15)
(r1, r15)
(r15, r1)
(r5, r15)
(r5, r3)
(r5, r1)
(r3, r1)
(r15, r5)
(r15, r3)
(r15, r2)
(r5, r2)
(r2, r5)
(r3, r2)
(r2, r3)
(r10, r12)
(r12, r10)
(r12, r16)
(r10, r16)
(r16, r10)
(r2, r15)
(r16, r12)

Group by leftmost record where the first record is common between the pairs:
{r1, r3, r5, r15}
{r2, r3, r5, r15}
{r3, r1, r2, r5, r15}
{r5, r1, r2, r3, r15}—duplicate
{r10, r12, r16}
{r12, r10, r16}—duplicate
{r15, r1, r2, r3, r5}—duplicate
{r16, r10, r12}—duplicate

Another round of generating pairs. Duplicates are not shown:
(r1, r3)
(r1, r5)
(r1, r15)
(r2, r3)
(r2, r5)
(r2, r15)
(r3, r5)
(r3, r15)
(r5, r15)
(r1, r2)
(r2, r1)
(r10, r12)
(r10, r16)
(r12, r16)

Rotate or reverse each pair. Duplicates are not shown:
(r1, r3)
(r3, r1)
(r1, r5)
(r5, r1)
(r1, r15)
(r16, r1)
(r2, r3)
(r3, r2)
(r2, r5)
(r5, r2)
(r2, r15)
(r15, r2)
(r3, r5)
(r5, r3)
(r3, r15)
(r15, r3)
(r5, r15)
(r15, r5)
(r1, r2)
(r2, r1)
(r10, r12)
(r12, r10)
(r10, r16)
(r16, r10)
(r12, r16)
(r16, r12)

Group by leftmost record where the first record is common between the pairs:
{r1, r2, r3, r5, r15}
{r3, r1, r2, r5, r15}—duplicate
{r5, r1, r2, r3, r15}—duplicate
{r10, r12, r16}
{r12, r10, r16}—duplicate
{r16, r10, r12}—duplicate

By repeating the example process of (1) creating pairs, (2) rotating or reversing each pair, (3) group by leftmost record, the subsets merge into the resulting groups illustrated in FIG. 8, which are {r1, r2, r3, r5, r15}, and {r10, r12, r16}.

### Example of Creating Inverted PID and Identity Stamping of Events

FIG. 9 illustrates an example process of associating inverted PIDs with identifiers, according to some embodiments. For each final group that is associated with one user, the credit data system can assign an inverted PID. The inverted PID may be generated by the credit data system in a sequential order. FIG. 9 provides two final groups, a first group 902 containing {r1, r2, r3, r5, r15} and a second group 904 containing {r10, r12, r16}. The first group is assigned an inverted PID of p1 whereas the second group is assigned an inverted PID of p2. Each inverted PID is associated with all of the records contained within the assigned group.

The credit data system can create an inverted PID map 426 containing associations between records and inverted PIDs. The inverted PID map 426 may be stored as a flat file or on a structured database. The credit data system may, once an inverted PID map is generated, incrementally update the map 426. As noted with respect to FIG. 8, each group represents a collection of all records (and unique identities contained within the records) that are associated with a particular user. Therefore, whenever two records have a same inverted PID, the credit data system may determine the records to be associated with a particular user regardless of the disparity in the records. The inverted PIDs can be used to stamp credit events.

FIG. 10 illustrates an example of identity stamping process. The credit data process can access and provide lender and/or account partitioned events 404 and the inverted PID map 426 as inputs to a stamping process 428 to generate PID stamped events 430 based on the one or more unique identities contained within the associated records. The stamped credit events 430 can be stored in a data store.

From the hash functions that group similar records into potential matches to set merging to stamping inverted PID to credit events, the credit data system maximizes grouping. Grouping is used to narrow the analyzed universe of credit events, and to quickly access credit events in the future. Using the intelligent grouping instead of performing computationally heavy searching, the credit data system is improved by orders of magnitude. For example, retrieving credit events associated with a user with inverted PID and generating a credit statement has improved 100 times in efficiency.

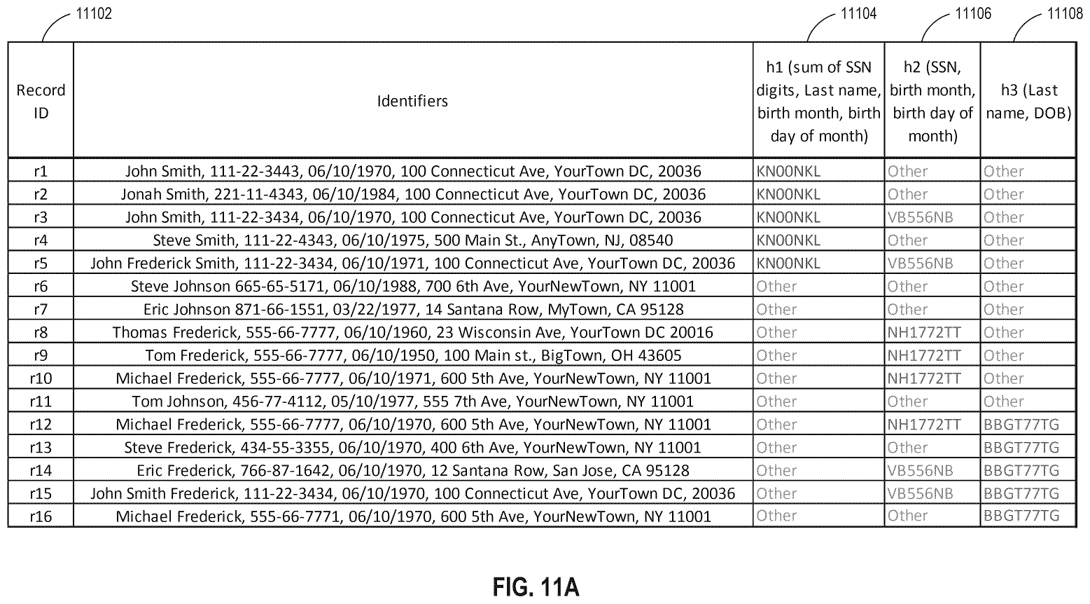

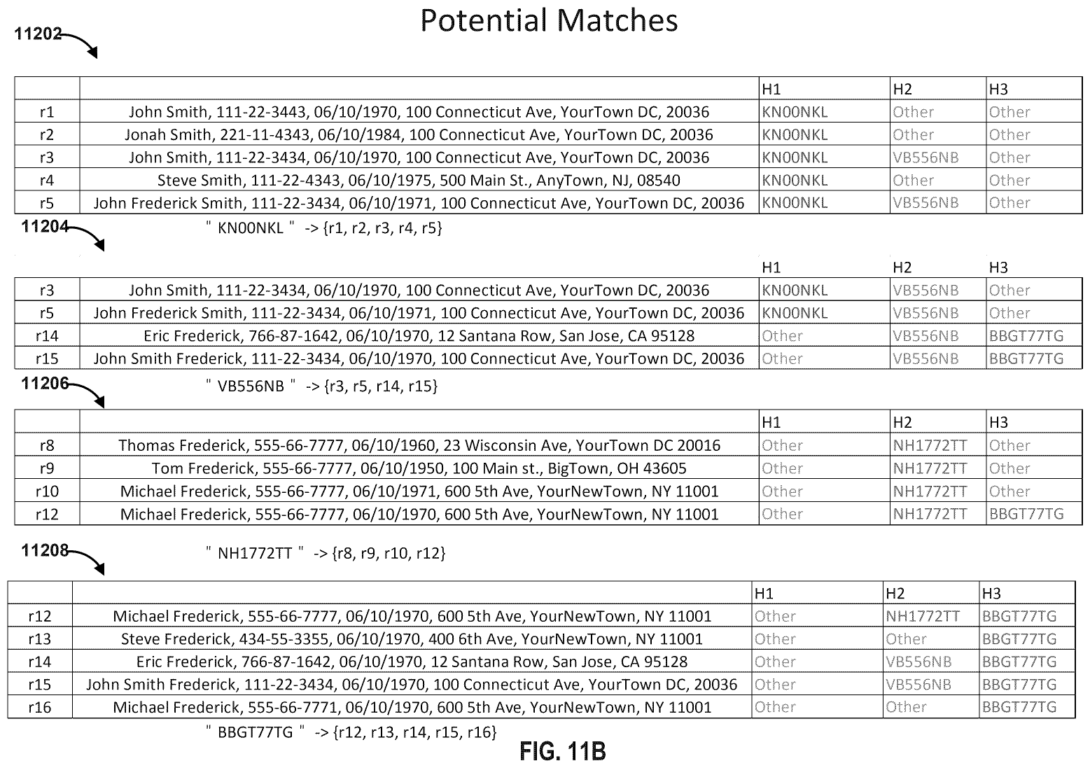

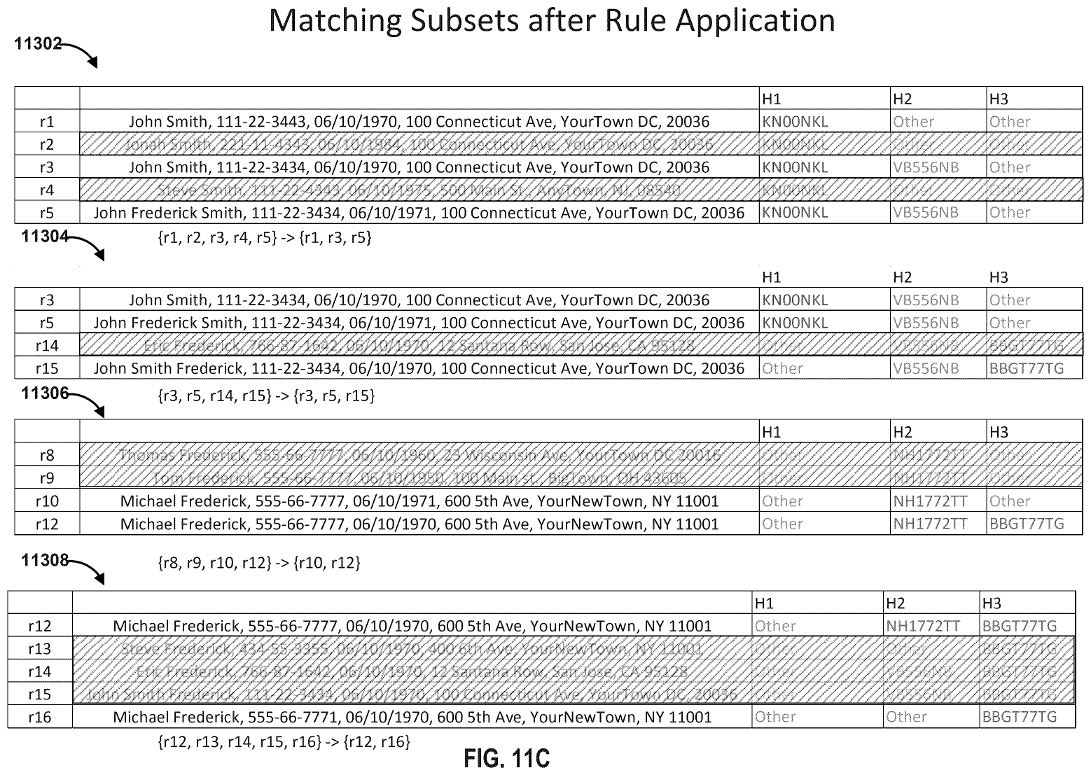

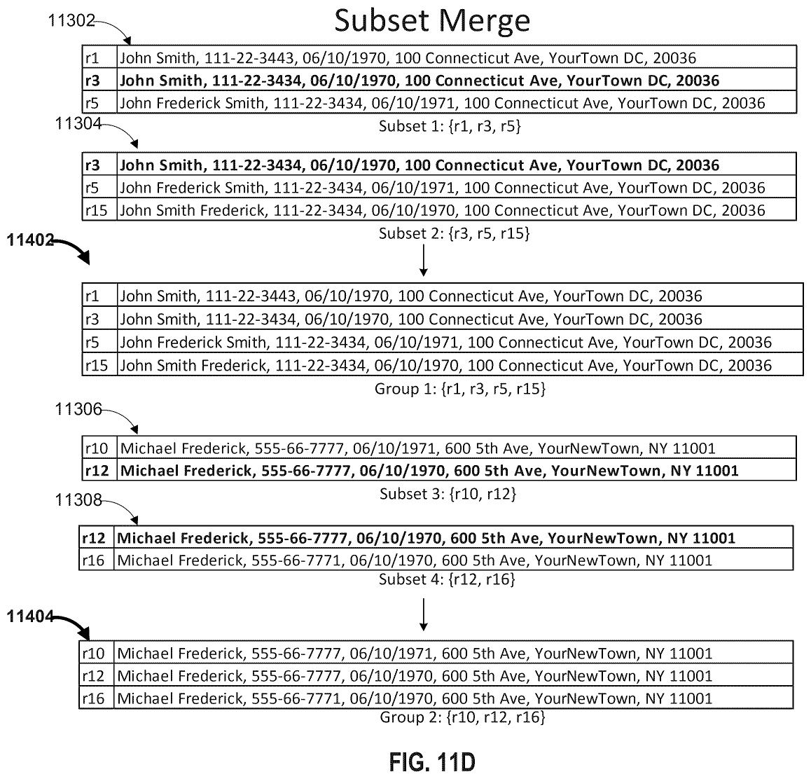

FIGS. 11A-11D illustrate, to facilitate the disclosure, the example identity matching process of FIG. 6-FIG. 8 with concrete data. FIG. 11A provides the example process of reducing dimensionality of data using hash algorithms applied to concrete values in a tabular form. The leftmost records column 11102 of the table in FIG. 11A lists records r1-r16 contained within credit events. For example, record r1 may be {“John Smith”, “111-22-3443”, “Jun. 10, 1970”, “100 Connecticut Ave”, “Washington DC”, “20036”} and record r2 may be {“Jonah Smith”, “221-11-4343”, “Jun. 10, 1984”, “100 Connecticut Ave”, “YourTown DC”, “20036”} and so forth.

These records contain user identifying information (for example, record r1 654 contains user identifying information “John Smith” (name), “111-22-3443” (SSN), “Jun. 10, 1970” (birthday), “100 Connecticut Ave” (street address), “YourTown DC” (city and state), “20036” (ZIP code). The user identifying information were extracted from credit events (FIG. 4, 406) and optionally deduplicated. The user identifying information can, alone or in combination, provide a unique identity, which can associate the record, and the associated credit event, to a particular user. As illustrated, the records can include unique identities.

Various financial institutions can provide more or less of different user identifying information. For example, VISA may provide only the first name and the last name (see, for example, r1) while American Express may provide middle name in addition to first name and last name (see, for example, r15). Some financial institutions may provide credit events that are missing one or more user identifying information all together, such as not providing driver's license number (for instance, r1-r16 do not include driver's license numbers).

Although there is no limit to how many hash functions may be applied to the records, FIG. 11A illustrates three example hash functions, h1 11104, h2 11106, and h3 11108. As described, each hash function can be designed to focus (i.e., increase or decrease collision rates) on different personal identifier or combinations of personal identifiers. Additionally, although not required, the personal identifiers can be pre-processed to generate hash keys that facilitate the objective of each hash functions. For example, hash function h1 11104 uses pre-processed hash key that “sums SSN digits, uses last name, birth month, birth day of month.” The record r1 can be pre-processed to provide a hash key “21Smith0610.” Using pre-processing of h1 11104, the records r2, r3, r4, and r5 will also provide the same hash key “21Smith0610.” However, for hash function h1 11104, the record r14 will provide a different hash key of “47Smith0610.” The different hash keys are likely to result in different hash values. For example, the same hash key “21Smith0610” of r1, r2, r3, r4, and r5 results in “KN00NKL” while the hash key “47Smith0610” resulted in some other hash value. Thus, according to the hash function h1 11104, the records sharing same hash value “KN00NKL” (i.e., r1, r2, r3, r4, and r5) are grouped as potential matches.

Hash function h2 11106 uses a different pre-processing, namely “SSN, birth month, birth day of month.” The records r3, r5, and r15, according to the pre-processing of h2 11106, produce a hash key of “111-22-34340610.” Using the hash function h2 11106, the hash keys calculate to “VB556NB.” However, hash functions can result in unintended collisions (in other words, false positives). The unintended collisions result in unintended record in a set of potential matches. For example, record r14, according to the pre-processing of the hash function h2 11106, resulted in a hash key of “766-87-16420610,” which is different with the hash key “111-22-34340610” associated with r3, r5, and r15, but nevertheless computed into same hash value “VB556NB.” Thus, when records are associated based on sharing a shame hash value from a hash function, the potential set of records belonging to a certain user may have unintendedly included a record belonging to a different user. As described, and also will be illustrated with concrete samples in FIG. 11B, matching rules can help resolve identity of the false positive records in each set.

Each hash function may result in more than one set of potential matching records. For example, FIG. 11A illustrates hash function computing two sets of hash values “VB556NB” and “NH1772TT.” Each hash value set is a set of potentially matching records. According to the example, hash function h2 11106 produces “VB556NB” hash value has a potentially matching record set {r3, r5, r14, r16} and “NH1772TT” hash value has a potentially matching record set {r8, r9, r10, r12}.

FIG. 11B illustrates the sets 11202, 11204, 11206, 11208 of potentially matching records according to their common hash values. Based on FIG. 11A, the potentially matching record set 11202 associated with the hash value “KN00NKL” includes {r1, r2, r3, r4, r5}. Similarly, the potentially matching record set 11204 associated with the hash value “VB556NB” includes {r3, r5, r14, r16}. The potentially matching record set 11206 associated with the hash value “NH1772TT” includes {r8, r9, r10, r12}. Similarly, the potentially matching record set 11208 associated with the hash value “BBGT77TG” includes {r12, r13, r14, r15, r16}.

Each set may include false positives. For example, although the potentially matching record set 11202 associated with the hash value “KN00NKL” includes {r1, r2, r3, r4, r5}, r2 and r4 do not seem to belong to the set of records that should be associated to John (Frederick) Smith because r2 has different “SSN and birth year” and r4 has different “first name, SSN, birth year, address, city, state, and ZIP code.” Determining whether any of the r1, r3, or r5 are false positives are trickier because there are only slight variations in SSN and birth year (rotated two digits in SSN or birth year that is only one year apart). Therefore, the records r2 and r4 are likely to be false positives while r1, r3, r5 are true positives. Similarly, other sets may contain true positives and false positives.

FIG. 11C illustrates application of one or more matching rules to resolve identity (i.e., remove such false positives) from the sets in FIG. 11B. Variety of match rules was disclosed with respect to FIG. 7. For example, applying one such rule of “exact match on last name, rotations of up to two digits in SSN AND birth year less than 2 years apart” can successfully remove the possible false positives from the set 11302, thereby providing a subset containing only {r1, r3, r5}. In some embodiments, the records in a set may be compared against an on file data of the user (e.g., verified user identifying information). In some embodiments, the records in a set themselves may be compared against each other to determine the highly probable true positive personal identifiers first then apply the matching rules against the determined personal identifiers.

In some embodiments, the matching rules can calculate confidence scores and compare against thresholds to accept or reject a record in a set. For example, the set 11304 with hash value “VB556NB” may use a rule that calculates character-matching score on name. The record r14 has full name “Eric Frederick” which at best, among other records in the set 11304, matches 9 characters out of 18 characters of “John Frederick Smith” and/or “John Smith Frederick.” Therefore, a score of 50% may be calculated and compared against a minimum match threshold of, say 70%, and the credit data system may reject r14 from the set 11304. Other matching rules can be designed and applied to the sets 11302, 11304, 11306, 11308 to remove rejected records and generate subsets. In some embodiments, some or all of such matching rules may be applied across different sets 11302, 11304, 11306, 11308. FIG. 11C illustrates, subsets that contain {r1, r3, r5}, {r3, r5, r15}, {r10, r12}, and {r12, r16}.

FIG. 11D illustrates application of set merging rules on subsets 11302, 11304, 11306, 11308 identified in FIG. 11C, thereby providing merged groups 11402, 11404. Each subsets 11302, 11304, 11306, 11308 from FIG. 11C contain records that can be associated with a user with high confidence. FIG. 11C, after the application of the matching rules, provides 4 such subsets. The first subset 11302 contains {r1, r3, r5} and the second subset 11304 contains {r3, r5, r15}.

A closer inspection of the first subset and the second subset reveals both subsets contain at least one common record, r3. Because each subset is associated with a unique user, all records in a same subset can also be associated with the same unique user. Logic dictates that if at least one common record exists in two disparate subsets that are associated with a unique user, the two disparate subsets should both be associated with the unique user and the two disparate subsets can be merged into a single group containing all the records in the two subsets. Therefore, based on the common record, r3, the first subset 11302 and the second subset 11304 are combined to yield a group 11402 containing all the records (i.e., {r1, r3, r5, r15} of the two subsets after the set merge process. Similarly, another group 11404 containing {r10, r12, r16} can be formed based on other subsets 11306 and 11308. After the set merge process is complete, all the resulting groups will have mutually exclusive records. Each merged groups may contain all the records containing unique identities associated with a user.

When the algorithm described in regards to FIG. 8 is applied to the original subsets:
{r1, r3, r5}, {r3, r5, r15}, {r10, r12}, and, {r12, r16}

Starting with the subsets, pairs of records (i.e., reducing each group into relationships of degree 2) are generated from the subsets. For example, the first subset containing {r1, r3, r5} can generate pairs:
(r1, r3)
(r1, r5)
(r3, r5)

The second subset containing {r3, r5, r15} can generate pairs:
(r3, r5)
(r3, r15)
(r5, r15)

The third subset containing {r10, r12} can generate pair:
(r10, r12)

The fourth subset containing {r12, r16} can generate pair:
(r12, r16)

The example merging process may list all the pairs. Because duplicates do not contain any additional information, the duplicates have been removed:
(r1, r3)
(r1, r5)
(r3, r5)
(r3, r15)
(r5, r15)
(r10, r12)
(r12, r16)

Rotate or reverse each pair:
(r1, r3)
(r3, r1)
(r1, r5)
(r5, r1)
(r3, r5)
(r5, r3)
(r3, r15)
(r15, r3)
(r5, r15)
(r15, r5)
(r10, r12)
(r12, r10)
(r12, r16)
(r16, r12)

Group by first record where the first record is common between the pairs:

{r1, r3, r5}
{r3, r1, r5, r15}
{r5, r1, r3, r15}
{r10, r12}
{r12, r10, r16}
{r15, r3, r5}
{r16, r12}

Another round of generating pairs. Duplicates are not shown:
(r3, r1)
(r3, r5)
(r3, r15)
(r1, r5)
(r1, r15)
(r5, r15)
(r10, r12)
(r16, r12)
(r10, r16)

Rotate or reverse each pair. Duplicates are not shown:
(r3, r1)
(r1, r3)
(r3, r5)
(r5, r3)
(r3, r15)
(r15, r3)
(r1, r5)
(r5, r1)
(r1, r15)
(r15, r1)
(r5, r15)
(r15, r5)
(r10, r12)
(r12, r10)
(r16, r12)
(r12, r16)
(r10, r16)
(r16, r10)

Group by leftmost record where the first record is common between the pairs:
{r1, r3, r5, r15}
{r3, r1, r5, r15}—duplicate
{r5, r1, r3, r15}—duplicate
{r10, r12, r16}
{r12, r10, r16}—duplicate
{r15, r1, r3, r5}—duplicate
{r16, r12, r10}—duplicate

After application of the set merging algorithm, two groups {r1, r3, r5, r15} and {r10, r12, r16} each containing mutually exclusive records remain.

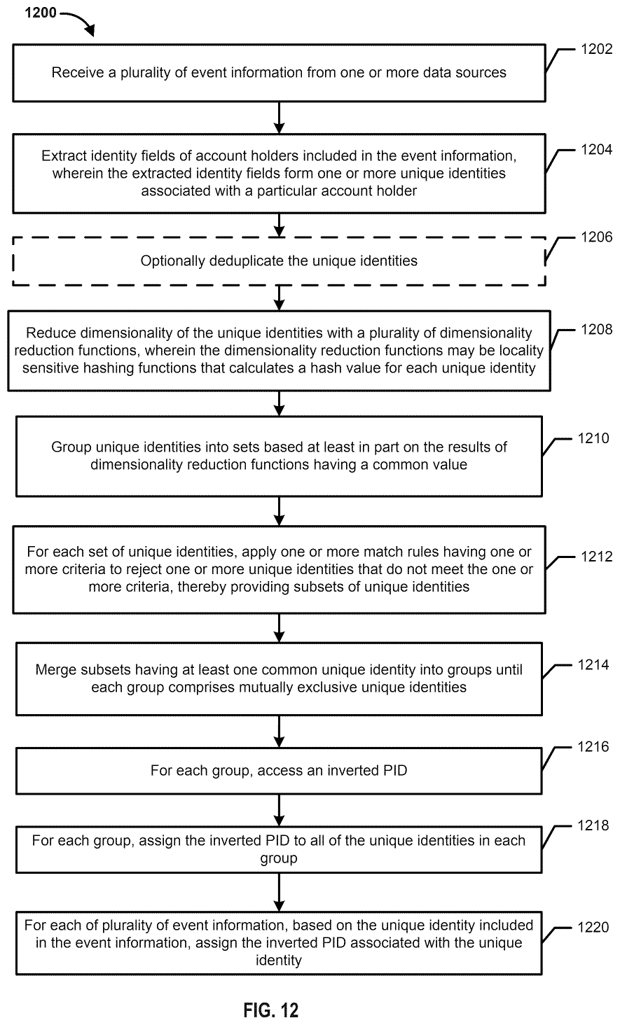

FIG. 12 is a flowchart 1200 of an illustrative method for efficiently organizing heterogeneous data at a massive scale. The illustrated method is implemented by a computing system, which may be a credit data system. The method 1200 begins at block 1202, where the computing system receives a plurality of event information from one or more data sources. The event information data source may be a financial institution. In some embodiments, the event information may have heterogeneous data structures between the event information from a same financial institution and/or across multiple financial institutions. The event information contains at least one personally identifiable information (“identity field” or “identifier) that associates the event information to an account holder who is associated with an account that generated the credit event. For example, credit event information (or for short, “credit event”) can contain one or more identity field that associates the credit event to a particular user who generated the credit event by executing a credit transaction.

The computer system may access the plurality of event information by directly accessing a memory device or data store where a pre-existing event information from the data sources are stored, or the event information may be obtained in real-time over a network.

At block 1204, the computer system may extract identity fields of account holders included in the event information. The identity field extraction can involve formatting, transformation, matching, parsing, or the like. The identity fields can include SSN, name, address, ZIP code, phone number, e-mail address, or anything that can be, alone or in combination, used to attribute event information to an account holder. For example, name and address may be enough to identify an account holder. Also, an SSN may be used to identify an account holder. When the event information count in the billions and are received from many data sources using heterogeneous formats, some accounts may not provide certain identity fields and some identity fields may contain mistyped or wrong information. Therefore, when working with a massive amount of event information, it is important to consider combinations of identity fields. For example, relying on just SSN to distinguish account holders can result in misidentification of associated account holders where SSN is mistyped. By relying on other available identity fields, such as names and address, a smart computer system can correctly attribute event information to a same user. Combinations of identity fields can form unique identities used to attribute event information to users who are associated with the events.

At block 1206, the computer system may optionally deduplicate the unique identities to remove same unique identities. For example, one event information may provide, when extracted, “John Smith”, “555-55-5555” (SSN), “jsmith@email.com” (e-mail), and “333-3333-3333” phone number. Another event may also provide “John Smith”, “555-55-5555” (SSN), “jsmith@email.com” (e-mail), and “333-3333-3333” phone number. The unique identities of the two event information are the same, and thus can be candidates for deduplication. One of the unique identities may be removed so that only the non-duplicated unique identities are subject to operations at block 1208.

At block 1208, the computer system may reduce dimensionality of the unique identities with a plurality of dimensionality reduction processes. Goal in this block is to “cluster” unique identities based on some similarities contained in the unique identities. An example process that may be used to reduce the dimensionality of the unique identities based on contained similarities may be a locality sensitive hashing function. The computer system may provide plurality such dimensionality reduction processes, each process focusing on one aspect of similarity contained within the unique identities, to provide multiple “clusters” of similar (and potentially attributable to a particular user) unique identities. When locality sensitive hashing functions are used, unique identities are associated with hash values, wherein each hash function applied generates a hash value for a given unique identity. Accordingly, each unique identity may be associated with a hash value for each hash function.

At block 1210, the computer system groups the unique identities into sets based at least in part on the results of the dimensionality reductions functions having a common value. The grouping into sets is extensively detailed at an abstract level with FIG. 6 and with concrete sample values with FIG. 11B. As described with respect to FIG. 6 and FIG. 11B, the resulting sets contain potential matches and can also contain false positives.

At block 1212, the computer system, for each set of unique identities, applies one or more match rules with criteria to remove the false positives. After the application of the match rules resulting in the removal of the false positives, the sets may become subsets of their previous sets before the application of the matching rules including only the verified unique identities.

At block 1214, the computer system merges the subsets to arrive at groups of unique identities. The set merge process includes identifying common unique identities in the subsets, and when the computer system finds at least one common unique identity, merges the subsets that contain the common unique identity. The set merging is extensively detailed at an abstract level with FIG. 8 and with concrete sample values with FIG. 11D. Also, an example of an efficient method of set merging was disclosed above. After the set merging, the merged groups include mutually exclusive unique identities.

At block 1216, the computer system provides a unique inverted PID for each of the groups. In a sense, this process is recognizing that each group represents a unique account holder. At block 1218, the computer system assigns the inverted PID provided for each group to all the unique identities contained within each associated group. In a sense, this process is recognizing that each of the unique identifiers, when found in event information, can identify the event information to belong to the particular account holder associated with the inverted PID.

At block 1220, the computer system inspects event information to find a unique identifier and, when a unique identifier is found, stamps the event information with an inverted PID associated with the unique identifier.

### Ingestion and Consumption of Heterogeneous Data Collections (HDC)

When a system is collecting and analyzing a massive amount of heterogeneous data, there exists a possibility that some of the incoming data contain or lead to a “defect.” Defect may be broadly defined as any factor that leads to a software modification or data conversion. For example, some financial institutions that report credit events may provide non-standardized data that requires extensive ETL processing as part of data ingestion. In the process of ETL, some defects may be introduced. An example may be phone numbers using “(###) ###-####” format as opposed to “###.###.####” format. Another example is European date format versus US date format. Yet another example may be defects introduced as a result of adoption of daylight savings time. Accordingly, these defects can be introduced due to a software bug in ETL process or lack of design generalizability. Sometimes, human errors can also be a factor and cause some forms of defects. Therefore, there is a room for improving existing systems that are inadequately prepared to address defect formation and handling.

Existing data integration approaches, such as data warehouses and data marts, attempt to extract meaningful data items from incoming data and transform them into a standardized target data structure. Often, as the number of data sources providing heterogeneous data grows, software and engineering efforts required to transform or otherwise address the growing number of heterogeneous data collection also grows in size and complexity. Such system requirements and human requirements can grow to a point that marginal effort of modifying existing system and maintaining the modified system can lead to more defects. For example, incorporating a new data sources and formats can require existing system's data structure to be modified, which can at times require conversion of existing data from old data format to a new data format. The conversion process can introduce new defects. If the defects go unnoticed for a long period of time, significant effort and cost must be expended to undo the effects of the defects through further software modifications and data conversions. Ironically, such further software modifications and data conversions can also lead to defects.

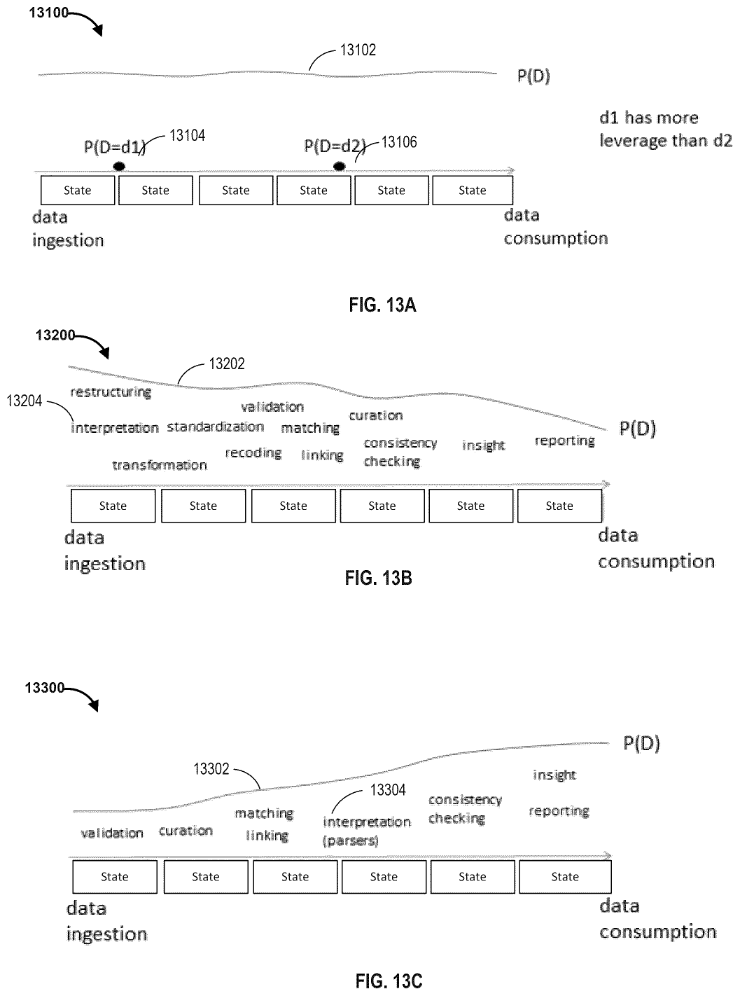

The credit data systems described herein address the defect management problem by implementing what may be called a “lazy interpretation” of data, which is further detailed with respect to defect models of FIGS. 13A-13C below.

### Defect Models

FIG. 13A is a general defect model 13100 showing defect probability associated with data as the data flows from data ingestion to data consumption (i.e., from left to right) across multiple system states. A system can have an associated “defect surface” 13102, which can be defined as the probability distribution of having defects for a given software component based upon its functional scope and design complexity. The height of the defect surface 13102 can reflect the defect probability P(D) for a combination of functional scope and design complexity. In other words, where software's functional scope and design complexity is high, the height of the defect surface 13102 will be high. Where software's functional scope and design complexity is low, the height of the defect surface 13102 will be low. The defect surface 13102 is mostly flat, indicating that software's functional scope and design complexity does not change across the states.

FIG. 13A also illustrates a related concept of “defect leverage.” A defect leverage can be defined as the amount (or, distance) of downstream software components that may be impacted by a given defect. A defect near data ingestion 13104 has greater distance toward downstream and thus has greater defect leverage than a defect near data consumption 13106. From the defect probability and defect leverage, a defect moment can be calculated, which can be defined as:

$$Defect Moment = Defect Probability * Defect Leverage .$$

The defect moment can be understood as a defect's probable impact on the system. An integrated sum of the defect moment can quantify the expected value of the amount of defects for the system. Therefore, minimizing the sum of defect moment is desirable.

FIG. 13B illustrates a defect surface model 13200 for a system using ETL processes. The restructuring, transformation, and standardization (all of which can be a part of ETL processes) are provided at the early data ingestion. Also, interpretation occurs at early ingestion as well in order to assist the ETL process. Insight gathering as part of analysis and reporting occur at the end of the data flow, near the data consumption.

As described, the ETL processes can increase in complexity when dealing with heterogeneous data sources. Accordingly, FIG. 13B illustrates a defect surface 13202 that is high (indicating high functional scope and software complexity) near the data ingestion and lower near the data consumption. The system exhibits highest defect surface 13202 where defect leverage is the highest (near data ingestion) and the lowest defect surface 13202 where the defect leverage is the lowest (near data consumption).

This type of high-to-low defect surface 13202 poses issues when defect moment is considered. Defect moment was defined as a product of defect probability and defect leverage, where the integrated sum of the defect moment quantifies the expected value of the amount of defects for the system. In this existing system, because high values are multiplied with high values and low values with low values, the integrated sum of the products can be quite large. Accordingly, the expected value of the amount of defects can be quite large.

FIG. 13C illustrates a defect surface model for the credit data system. Contrary to the existing systems, the credit data system does not execute ETL processes (e.g., restructuring, transformation, standardization, recoding, etc.) but may limit its processing to validating, curating (e.g., performing quality control), and matching/linking the incoming data. The validation, curation, and matching/linking processes are not as complex as the software components for ETL process and have low probability of defect. Thus, FIG. 13C illustrates the credit data system's defect surface 13302 low near the data ingestion and high near the data consumption. Accordingly, the credit data system exhibits lowest defect surface 13302 where defect leverage is the highest (near data ingestion) and the highest defect surface 13302 where the defect leverage is the lowest (near data consumption).

This type of low-to-high defect surface 13302 is highly beneficial when defect moment is considered. In the credit data system, because low defect probabilities are multiplied with high defect leverages and high defect probabilities are multiplied with low defect leverages, the integrated sum of the products can be much smaller than in existing systems. Therefore, the credit data system provides an improved defect management in relation to data ingestion and data consumption.

### Lazy Interpretation of Data

A “lazy interpretation” system, instead of interpreting incoming data near data ingestion (as the data model 13200 for traditional systems in FIG. 13B illustrates), delays the interpretation as late as possible in the data-to-insight pipeline in order to minimize the integrated defect moment. FIG. 13C illustrates an example defect model 13300 of such lazy interpretation system according to one implementation.

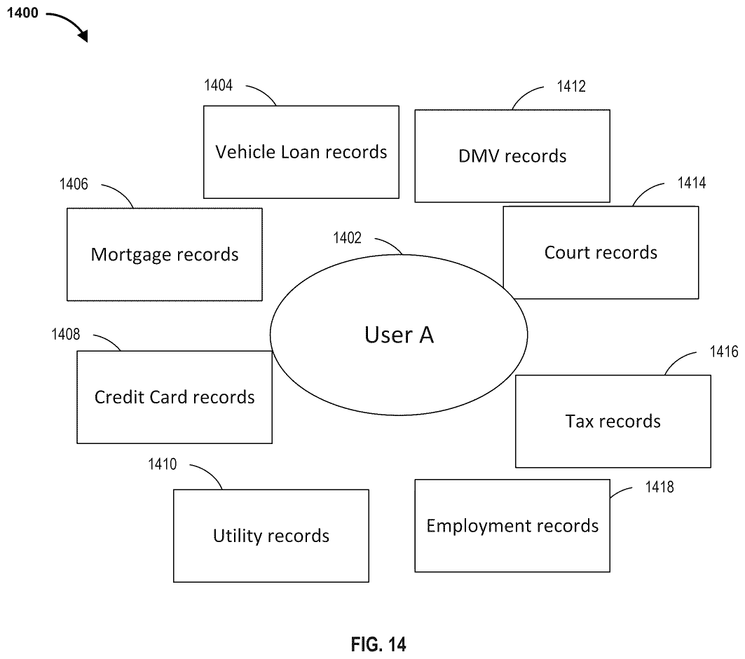

The lazy interpretation system can accept any type of event data, such as from data sources that have various data types, formats, structures, meanings, etc.. For example, FIG. 14 illustrates various types of event data related to an anchoring entity 1402, shown as a particular user in this example. An anchoring entity may be any other entity for which resolution of event data is provided. For example, an anchoring entity may be a particular user and various data sources may provide heterogeneous data events, such as vehicle loan records 1404, mortgage records 1406, credit card records 1408, utility records 1410, DMV records 1412, court records 1414, tax records 1416, employment records 1418, etc., associated with the particular user.

In some embodiments, as new event data is accessed, the system identifies only the minimal information required to attach the data to a correct anchoring entity. For example, an anchoring entity may be a particular user and the minimum information required for attaching the new data to the particular user may be identifying information such as name, national ID, or address. When receiving new data, the system may look for this minimal set of identifying information of the particular user in the data and attaches the data with one or more user association tags (for example, where anchoring entity is a user associated with credit events, an inverted PID is one example of a user-associated tag). For a given data, the lazy interpretation system can later use the tags to identify a correct anchoring entity. The process of attaching a tag can be the matching/linking process in FIG. 13C. In some embodiments, the matching/linking process does not alter the incoming data or data structure.

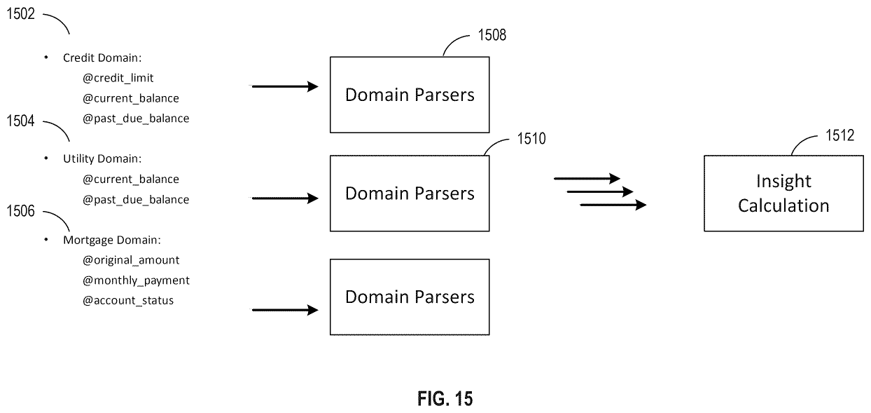

The tagging/matching/linking process may be akin to cataloging a book. For example, based on an International Standard Book Number (“ISBN”), book title, and/or author of a book, a librarian can place the book on a correct section and shelf. The content or plot of the book is not necessary in the cataloging process. Similarly, based on minimal information that identifies an anchoring entity, a vehicle loan record 1404 can be associated with a particular anchoring entity. In some embodiments, each record and/or data source may be associated with a domain (further described with respect to FIG. 15). For example, a vehicle loan record 1404 or the vehicle loan data source may be associated with a “vehicle loan domain,” a credit card record 1408 or the credit card data source may be associated with a “credit domain,” and a mortgage record 1406 or the mortgage data source may be associated with a “mortgage domain.”

In some embodiments, the lazy interpretation system may include an Anchoring Entity Resolution (AER) process that corrects tags attached to the previously received data to be associated with the best known anchoring entity. The best known anchoring entity may dynamically change based on information contained in the new incoming data, such as based on the analytics of previously received data, or based on improvements in anchoring entity resolution itself. In some embodiments, the anchoring entity resolution may update the previously attached tags. The anchoring entity resolution process may periodically or continuously run in the background or foreground, may be automatically triggered by the occurrence of a predefined event, and/or initiated by a system overseer, requesting entity, or other user.

The lazy interpretation system limits the probability of defect to the interpretation and handling of identifying information. By doing away with the ETL processes of traditional systems, the lazy interpretation system reduces software and engineering efforts required to transform or otherwise address the growing size and complexity of heterogeneous data collection. As FIG. 13C illustrates, the defect surface 13302 is lowered for states that are further upstream from the states near the data consumption, thereby reducing the defect moments.

### Domain Dictionary and Vocabulary

The lazy interpretation system may include one or more parsers (FIG. 13C, 13304) for interpretation of data. Unlike existing systems with interpretation component (FIG. 13B, 13204) positioned near the data ingestion, the lazy interpretation system has the interpretation component (e.g., “parsers”) positioned further toward the data consumption (FIG. 13C, 13304). Parsers may be associated with domains, such as credit domain 1502, utility domain 1504, and/or mortgage domain 1506.

The lazy interpretation system may associate incoming data or data sources with one or more domains. For example, a credit card record 1408 or its data source may have been associated with the “credit domain.” Each domain includes a dictionary that includes vocabulary for the domain. FIG. 15 illustrates domains and their associated vocabularies. For example, a credit domain 1502 may have an associated dictionary including vocabulary of “@credit_limit,” “@current_balance,” and “@past_due_balance.” Similarly, a utility domain 1504 may have an associated dictionary including vocabulary of “@current_balance,” and “@past_due_balance” As illustrated, vocabularies may be repeated across different domains, such as “@current_balance” and “past_due_balance.” However, each domain has its sets of rules for interpretation and parsers associated with a particular domain can appropriately interpret identical vocabulary in one domain distinctly from the vocabulary in another domain based on each record's respective domain.

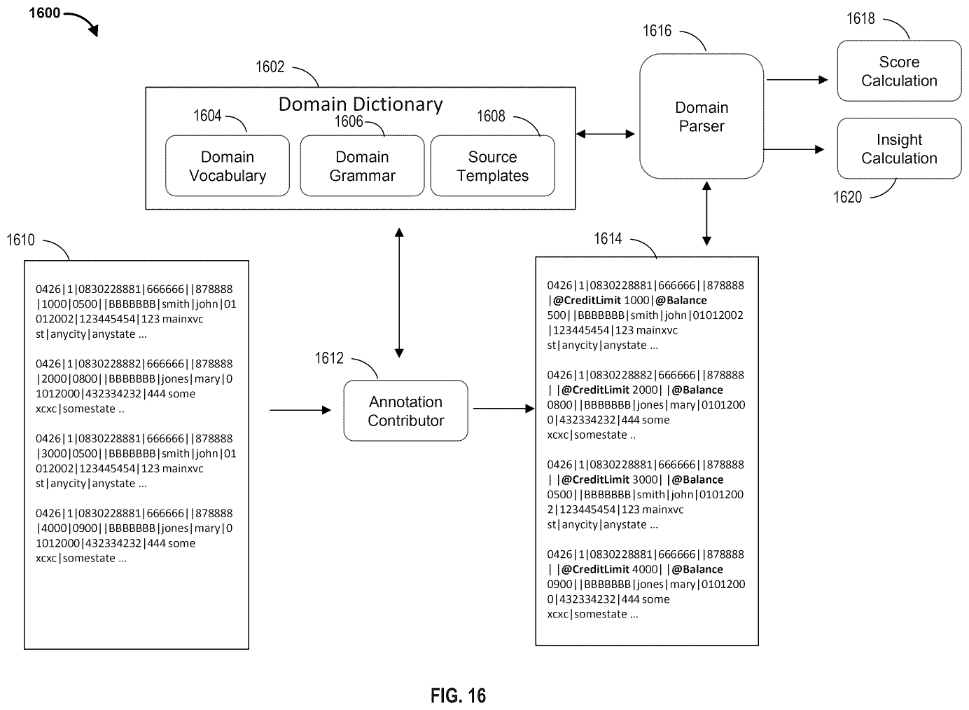

Based on the dictionary and the vocabularies contained within, the one or more parsers inspect the contents of the records and tag fields or values with the matching vocabulary. The parsing process may be akin to scanning through the books to identify/interpret relevant content. Similar to scanning history books for contents relevant to “George Washington” and tagging contents describing George Washington's birthplace, birth date, age, or the like with “@george_washington,” a credit parser 1508 may scan records from a credit data source or records in the credit domain and identify/interpret contents that could be relevant to credit limit and tag the identified/interpreted contents with “@credit_limit” tag (FIG. 16 illustrates examples of tagging identified contents with @credit_limit). Similarly a utility domain parser 1510 may scan records, such as a utility invoice, from a utility data source or records in the utility domain and identify contents that could be relevant to past due balance and tag the identified contents with “@past_due_balance” tag.

Once tagged, downstream components including consistency checking, insight, and/or reporting in FIG. 13C can analyze the content of a record using the vocabulary for the record's domain. In some embodiments, a downstream component (e.g., any insight calculation component 1512) may interpret records from more than one domain for its use. For example, a mortgage scoring component can look for “@credit_limit” in data from the credit domain before making a determination on a potential mortgagee's creditworthiness.

Advantageously, the lazy interpretation provides the benefit of reducing the defects' effects. The above described interpretation by the parsers is, as FIG. 13C, 13304 illustrates, closer to the data consumption than the interpretation existing systems offer. Therefore, the defects in the lazy interpretation system have limited leverage, and thus have reduced impact.

Another benefit the lazy interpretation system provides is that the system does not need to alter the original or existing heterogeneous event data. Instead of ETL processing to standardize the data for storage and interpretation, the system tags and postpones interpretation to parsers. If one or more parsers are found to introduce defects into a domain, a data engineer simply can update the one or more domain parsers. Because the original or existing event data has not been altered, re-executing parsers can quickly eliminate defects without loss of data. Additionally, in some embodiments, because a data is not copied throughout the data flow, a data engineer may curate, delete, or exclude any data without needing to update other databases.

Therefore, the lazy interpretation system's data ingestion does not need ETL processes and, therefore, the lazy interpretation system allows new data sources to be brought in rapidly and at low cost.

FIG. 16 illustrates an example process 1600 of lazy interpretation using some sample content, according to some embodiments. A domain dictionary 1602 may include a domain vocabulary 1604 and domain grammar 1606. The domain vocabulary 1604 may include keyword definitions for annotating (e.g., tagging as described with respect to FIG. 15) data. The domain vocabulary 1604 can include “primary words” and “composite words.” In some embodiments, the primary words are tags that are directly associated (or “annotated”) with some portion of the heterogeneous data. For example, the lazy interpretation system tagged some portion of the incoming data 1610 with @CreditLimit and @Balance. Composite words are synthesized from one or more primary words or other variables with domain grammar 1606. An example of domain grammar 1606 may be that “an average balance for N records equals summing each account balance and dividing by N,” which may be expressed in domain grammar 1606 with two primary words @Balance as “@AverageBalance[n]=Sum(@Balance)/n).

The domain dictionary 1602 may also include predefined source templates 1608 for heterogeneous data sources. The source templates 1608 act as a lens to expose important fields. For example, a simple example source template can be “for incoming data 1610 from a VISA data source, 6^{th} data field is a @CreditLimit and 7^{th} data field is a @Balance.” The annotation contributor 1612 can use one or more such source templates 1608 to tag/annotate incoming data in a domain to generate annotated data 1614. In some embodiments, machine learned models and/or other artificial intelligence may be used to supplement or replace source templates 1608 in determining and exposing important fields.

The lazy interpretation system may also include one or more domain parsers 1616. The domain parser 1616 can use annotations/tags and rules embedded in its software to present fully annotated data to applications. In some embodiments, the domain parser can, in addition to or in place of the annotations/tags that the annotation contributor 1612 provides, provide some annotations/tags to generate the fully annotated data. The domain parser 1616 can refer to the domain dictionary 1602 in its presentation of the fully annotated data to the applications or in its own annotation/tagging.

A score calculation application 1618 and an insight calculation application 1620 are provided as the example applications that can use the fully annotated data. The score calculation application 1618 may, based on the annotated data calculate a credit score (or other scores) of one or more users and provide to a requesting entity. Similarly, the insight calculation application 1620 may provide analytics or reports including balance statement, cash flow statement, spending habits, possible saving tips, etc. In some embodiments, various applications, including the score calculation 1618 and insight calculation 1620 applications, may use the fully annotated data in conjunction with the inverted PID from the batch indexing process to quickly identify all the annotated records belonging to a particular user and generate a report or analytic relating to the user.

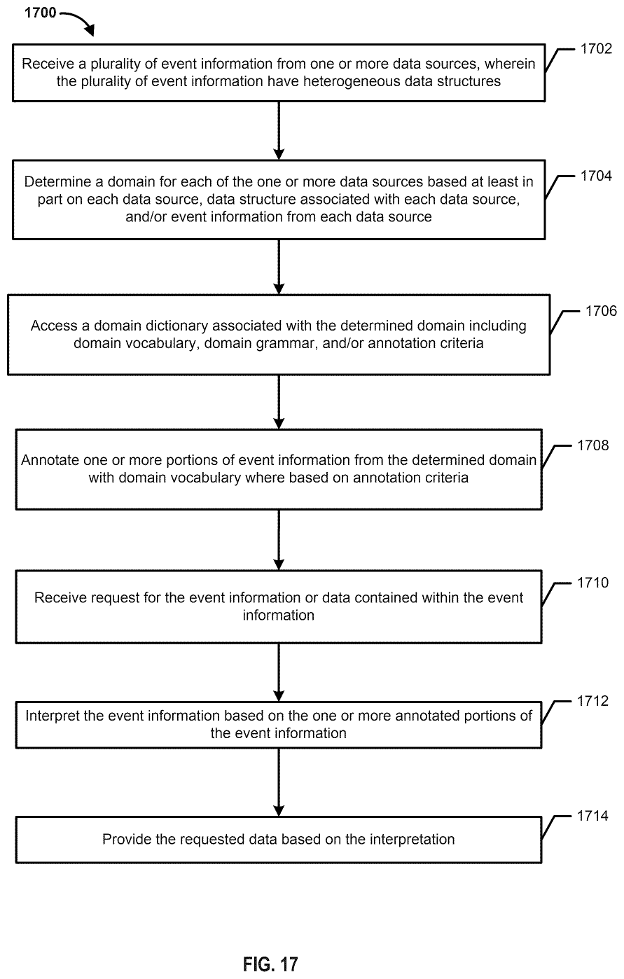

FIG. 17 is a flowchart 1700 of an illustrative method for interpreting incoming data so as to minimize defect impact in the system, according to some embodiments. Depending on the embodiment, the method of FIG. 17 may include fewer or additional blocks and the blocks may be performed in an order that is different than illustrated.

Beginning at block 1702, the interpretation system (e.g., one or more components of the credit data system discussed elsewhere herein) receives a plurality of event information (see, FIG. 14) from one or more data sources. A data source may be a mortgager, credit card provider, utility company, vehicle dealer providing vehicle loan records, DMV, courts, IRS, employer, banks, or any other source of information that may be associated with entities for which entity resolution is desired. In some embodiments, the data sources provide the plurality of event information in heterogeneous data formats or structures.

At block 1704, the lazy interpretation system determines a category or type of information (also referred to herein as a “domain”) associated with the data sources. The determination of a domain for a data source may be based on information provided by the data source. In some embodiments, the system may be able to determine (or confirm in situations where the data source provides domain information) the associated domain from inspection of the data source's data structure. In some embodiments, the event information may include some cues indicative of the domain of a particular data source and the system may be able to determine a domain for the data source based on the cues. For example, if event information (or a large portion of event information) includes the terms “water” or “gas,” the system may automatically determine that the data source should be associated with a utility domain.

At block 1706, the system accesses a domain dictionary for the determined domain. The domain dictionary may include a domain vocabulary, domain grammar, and/or annotation criteria, examples of wherein are described above with respect to FIG. 16.

At block 1708, the system annotates event information from the determined domain with the domain's dictionary. For example, based on the annotation criteria, the system evaluates the event information and identifies one or more portions which can be annotated with domain vocabulary. FIG. 16 illustrates example event information 1610 before annotation and then the annotated event information 1614 with annotations associated with certain event information. In some embodiments, the event information are updated only with the domain annotations (such as in the example annotated event information 1614) and are otherwise unaltered. In some embodiments, once event information are annotated, they are left undisturbed until the system receives a data request for the event information, such as information associated with particular annotations (e.g., requests for @Creditlimit data of event information may be requested to calculate an overall credit limit across multiple accounts of a consumer, which may be included in a credit report or similar consumer risk analysis report).

At block 1710, the system receives data requests for event information. The requests may be for the event information (e.g., all event information that includes a particular annotation or combination of annotations) or for particular data included in the event information (e.g., portions of event information specifically associated with an annotation). For example, with respect to the annotated event information 1614 of FIG. 16, a request may be for the whole annotated credit event information or only @Balance data in the credit event information. The data request may be from another component of the system, such as score calculation application, insight calculation application, or the like, or may be from another requesting entities, such as a third party.

At block 1712, the system analyzes event information with one or more domain parsers to identify the information requested. As described with reference to FIG. 16, the domain parsers may use the domain dictionaries to interpret the event information. For example, a domain parser may use a domain vocabulary to find one or more primary words. Then, the domain parser may use a domain grammar to determine a composite word based on the one or more primary words. In some embodiments, a domain parser may request another domain parser to provide necessary data for its interpretation. For example, a mortgage domain parser may request @credit_score from a credit domain parser in generating its composite word according to a domain grammar requiring a credit score. At block 1714, the system provides the requested data to a requesting application or a requesting entity.

### Additional Embodiments

It is to be understood that not necessarily all objects or advantages may be achieved in accordance with any particular embodiment described herein. Thus, for example, certain embodiments may be configured to operate in a manner that achieves or optimizes one advantage or group of advantages as taught herein without necessarily achieving other objects or advantages as may be taught or suggested herein.

All of the processes described herein may be embodied in, and fully automated, via software code modules executed by a computing system that includes one or more computers or processors. In some embodiments, at least some of the processes may be implemented using virtualization techniques such as, for example, cloud computing, application containerization, or Lambda architecture, etc., alone or in combination. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

Conditional language such as, among others, “can,” “could,” “might” or “may,” unless specifically stated otherwise, are understood within the context as used in general to convey that certain embodiments include, while other embodiments do not include, certain features, elements and/or processes. Thus, such conditional language is not generally intended to imply that features, elements and/or processes are in any way required for one or more embodiments or that one or more embodiments necessarily include logic for deciding, with or without user input or prompting, whether these features, elements and/or processes are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. (canceled)

2. A computer-implemented method to determine account holder identities for collected event information, the computer-implemented method comprising:
as implemented by one or more computing devices comprising one or more hardware processors and configured with specific computer-executable instructions,
receiving, from a plurality of data sources, a plurality of event information that comprises heterogeneous data structures;
for each event information, accessing source-specific parameters defining identifiers available from a corresponding data source, and extracting one or more identifiers from the event information based on the source-specific parameters, wherein a combination of the extracted identifiers comprises a unique identity associated with a unique user;
for each unique identity, calculating a plurality of hashes by evaluating a plurality of hash functions, each associated with a combination of identifiers;
based on whether unique identities share a common hash calculated with a common hash function, selectively grouping unique identities into sets of unique identities associated with common hashes;
for each set of unique identities:
applying one or more match rules including criteria for comparing unique identities within the set; and
determining a matching set of unique identities as those meeting one or more of the match rules;
merging matching sets of unique identities each including at least one common unique identity to provide one or more merged sets comprising no unique identity in common with other merged sets by repeating until the matching sets are merged, a process of creating pairs of records from each matching set, reversing each pair, and grouping by leftmost record where the leftmost record is common between the pairs, each merged set associated with one user;
for each merged set:
determining an inverted personal identifier; and
associating the inverted personal identifier to each of the unique identities in the merged set to create an inverted personal identifier map; and
for each unique identity, using the inverted personal identifier map to:
identify event information associated with at least one of the combinations of identifiers associated with the unique identity; and
associate the inverted personal identifier with the identified event information, wherein each inverted personal identifier is associated with multiple unique identities in the merged set associated with the unique user and wherein the identified event information is associated with multiple events that are associated with the unique user.

3. The computer-implemented method of claim 2, wherein the hash functions include at least:
a first hash function that evaluates a first combination of at least portions of a first identifier and at least portions of a second identifier extracted from event information; and
a second hash function that evaluates a second combination of at least portions of the first identifier and at least portions of a third identifier extracted from event information.

4. The computer-implemented method of claim 2, wherein accessing source-specific parameters comprises accessing, from a data store, associations between data sources and identifier parameters defining the identifiers to extract from event information of each corresponding data source.

5. The computer-implemented method of claim 3, wherein the first identifier is a social security number of the unique user and the second identifier is a last name of the unique user, and the first combination is a concatenation less than all digits of the social security number and less than all characters of the last name of the unique user.

6. The computer-implemented method of claim 3, wherein a first set of events includes a plurality of events associated with the first hash and a second set of events includes the plurality of events associated with the second hash.

7. The computer-implemented method of claim 2, wherein the identifiers are selected from: first name, last name, middle initial, middle name, date of birth, social security number, taxpayer ID, or national ID.

8. The computer-implemented method of claim 2 further comprising generating an inverted map associating an inverted personal identifier to each of the remaining unique identities in the merged sets and stores the map in a data store.

9. The computer-implemented method of claim 2 further comprising, based on the inverted personal identifier assigned to the remaining unique identities, assigning the inverted personal identifier to each of the plurality of event information including the remaining unique identities.

10. The computer-implemented method of claim 2, wherein the hash functions comprise locality sensitive hashing.

11. The computer-implemented method of claim 2, wherein the one or more match rules include one or more identity resolution rules that compare unique identities in the one or more sets with account holder information in an external database or CRM system to identify matches to the one or more match rules.

12. The computer-implemented method of claim 11, wherein the identity resolution rules include criteria indicating match criteria between the account holder information and the identifiers.

13. The computer-implemented method of claim 2, wherein creating pairs of records from each matching set includes pairing each unique identity in a set with another unique identity in the set to create pairs of unique identity wherein grouping by the leftmost record where the leftmost record is common between the pairs includes grouping noncommon unique identities from the pairs with the common unique identity until lists of unique identities contained within resulting groups are mutually exclusive between resulting groups.

14. The computer-implemented method of claim 13 further comprising sorting the unique identities in pairs.

15. The computer-implemented method of claim 2, wherein the plurality of event information comprises information about at least one credit event.

16. Non-transitory, computer-readable storage media storing computer-executable instructions that, when executed by a computer system that comprises one or more hardware processors, configure the computer system to perform operations comprising:
receiving, from a plurality of data sources, a plurality of event information that comprises heterogeneous data structures;
for each event information, accessing source-specific parameters defining identifiers available from a corresponding data source, and extracting one or more identifiers from the event information based on the source-specific parameters, wherein a combination of the extracted identifiers comprises a unique identity associated with a unique user;
for each unique identity, calculating a plurality of hashes by evaluating a plurality of hash functions, each associated with a combination of identifiers;
based on whether unique identities share a common hash calculated with a common hash function, selectively grouping unique identities into sets of unique identities associated with common hashes;
for each set of unique identities:
applying one or more match rules including criteria for comparing unique identities within the set; and
determining a matching set of unique identities as those meeting one or more of the match rules;
merging matching sets of unique identities each including at least one common unique identity to provide one or more merged sets comprising no unique identity in common with other merged sets by repeating until the matching sets are merged, a process of creating pairs of records from each matching set, reversing each pair, and grouping by leftmost record where the leftmost record is common between the pairs, each merged set associated with one user;
for each merged set:
determining an inverted personal identifier; and
associating the inverted personal identifier to each of the unique identities in the merged set to create an inverted personal identifier map; and
for each unique identity, using the inverted personal identifier map to:
identify event information associated with at least one of the combinations of identifiers associated with the unique identity; and
associate the inverted personal identifier with the identified event information, wherein each inverted personal identifier is associated with multiple unique identities in the merged set associated with the unique user and wherein the identified event information is associated with multiple events that are associated with the unique user.

17. The non-transitory, computer-readable storage media of claim 16 wherein the computer system is further configured to generate an inverted map associating an inverted personal identifier to each of the remaining unique identities in the merged sets and stores the map in a data store.

18. The non-transitory, computer-readable storage media of claim 16 wherein the computer system is further configured to, based on the inverted personal identifier assigned to the remaining unique identities, assign the inverted personal identifier to each of the plurality of event information including the remaining unique identities.

19. The non-transitory, computer-readable storage media of claim 16, wherein the hash functions comprise locality sensitive hashing.

20. The non-transitory, computer-readable storage media of claim 16, wherein the one or more match rules include one or more identity resolution rules that compare unique identities in the one or more sets with account holder information in an external database or CRM system to identify matches to the one or more match rules.

21. The non-transitory, computer-readable storage media of claim 16 wherein the plurality of event information comprises information about at least one credit event.
